(19) United States
(12) Patent Application Publication
(10) Pub. No.: US 2026/0082441 A1
(43) Pub. Date: Mar. 19, 2026

(54) REAL TIME AND NON-REAL TIME SERVICE COMMUNICATION CHANNELS FOR NEXT GENERATION DATA TRANSMISSION

(71) Applicant: DISH Wireless L.L.C., Englewood, CO (US)

(72) Inventor: Madhuri Muttreja, Parker, CO (US)

(21) Appl. No.: 19/231,673

(22) Filed: Jun. 9, 2025

Related U.S. Application Data
(60) Provisional application No. 63/696,083, filed on Sep. 18, 2024.

(51) Int. Cl. H04W 76/15; G06F 13/38

(52) U.S. Cl. CPC H04W 76/15; G06F 13/38

(57) ABSTRACT

Technologies for providing large data throughput communication in a next generation cellular network (e.g., 5G wireless network, 6G wireless network) are described. The method includes receiving requests from producers and consumers for integration into a communication pathway. Based on producer data output, the producer can be connected to a message bus that can store data from the producer in short-term data store or long-term data store. A data consumer can request data of a data type or from a data producer be provided from the message bus to the data consumer. Based on the immediate usability of the data by the consumer, the consumer can direct to the message bus to store data in a short-term data store for quick transfer to the consumer for real-time data consumption, or to a long-term data store to be stored until the consumer is available for the data.

### RELATED APPLICATIONS

This application claims the benefit of U.S. Patent Application No. 63/696,083, filed Sep. 18, 2024, the entire contents of which are incorporated herein by reference.

### BACKGROUND

This disclosure relates to wireless data networks. Wireless data networks that transport digital data and telephone calls are becoming increasingly sophisticated. Currently, fifth generation (5G) broadband cellular networks are being deployed worldwide. These networks use emerging technologies to support data and voice communications for millions, if not billions, of mobile phones, computers, and other devices. 5G technologies are capable of supplying much greater bandwidths than previously available technologies. In addition, it is expected that higher data rates will be required in 6G and subsequent generations.

These wireless data networks can collect and distribute more data than previous generations. Centralizing large volumes of data is expensive and time-consuming, which can reduce the speed advantages offered by 5G networks.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram of a cellular network system implementing a message bus system in a cellular network, according to at least one embodiment;

FIG. 2 is a block diagram of a system implementing one or more message buses within a cellular network according to at least one embodiment;

FIG. 3 shows one or more producers utilizing one or more message buses within the cellular network according to at least one embodiment;

FIG. 4 shows one or more consumers utilizing one or more message buses within the system according to at least one embodiment;

FIG. 5 shows smart message bus utilization for connecting one or more producers to one or more consumers according to at least one embodiment;

FIG. 6 shows message buses within a central system, at an edge distribution center, and in cloud storage according to at least one embodiment;

FIG. 7 shows telecommunication edge channels deployed for edge distribution center capabilities according to at least one embodiment;

FIG. 8 illustrates an example graphical user interface for data producers connecting to the message buses of FIG. 2 according to at least one embodiment;

FIG. 9 illustrates an example graphical user interface for data consumers connecting to the message buses of FIG. 2 according to at least one embodiment;

FIG. 10 is logical flow diagram for smart producer and consumer configuration of message bus connection architecture according to at least one embodiment;

FIG. 11 shows an illustrative topic governance logic table for next generation data configuration according to at least one embodiment;

FIG. 12 is a flow diagram of a method for providing real-time and non-real-time service communication channels according to at least one embodiment;

FIG. 13 is a flow diagram of a method for intelligent communication channel generation for next generation data transmission according to at least one embodiment;

FIG. 14 is a flow diagram of a method for connecting clients to a message bus according to at least one embodiment;

FIG. 15 is a flow diagram of a method of selecting and providing message buses at edge telecommunication locations according to at least one embodiment; and

FIG. 16 flow diagram of a method of identifying data for message bus transmission based on topic governance rules according to at least one embodiment.

### DETAILED DESCRIPTION

Technologies for enabling scalable large data throughput communications in O-RAN data collection systems in a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, collection and distribution data using current and subsequent generation data transmission technologies (e.g., 5G, 6G, etc.) may require more storage space and may be transmitted at slower rates. Aspects and embodiments of the present disclosure address these problems and others by enabling non-physical connections between data producers and consumers to enable transmission of high amounts of data. Specifically, within open radio access network (O-RAN) data collection systems, producers of data may be segmented into sub-producers that require data transmission and storage methods to enable consumers to consume the specially segmented data.

Telecommunication systems, particularly those utilizing 4G and earlier network generations, typically employ vertically integrated and proprietary radio access network (RAN) components. These RAN architectures often consist of tightly coupled elements such as the Radio Unit (RU), Distributed Unit (DU), and Centralized Unit (CU), all provided by a single vendor. This design results in a monolithic, non-flexible network structure with limited interoperability between components. Additionally, the inability to independently scale and upgrade these components has limited innovation and cost-efficiency.

The advent of 5G and the transition toward 6G networks, however, demands an increased level of flexibility, scalability, and interoperability. Open RAN (O-RAN) enables the disaggregation of the RAN into separate, modular components that can operate independently while communicating via standardized, open interfaces. This disaggregation allows for multi-vendor solutions, more efficient resource allocation, and the ability to tailor the network to specific use cases and geographic needs.

However, the disaggregation of RAN components results in a significant increase in the volume and complexity of the data being produced. The increased volume of data generated by these network elements poses substantial challenges in terms of data management, network optimization, and infrastructure requirements. To monitor health and functionality of the telecommunication network (also referred to as “telecom network”), improved methods of data communication are required. Furthermore, the scale of the data produced by disaggregated RAN components necessitates advanced data processing capabilities and the integration of technologies such as Artificial Intelligence (AI), Machine Learning (ML), and edge computing.

The increase in technical demands caused by the increase in data generation and variability of data generation requires advancements in data transmission technology within O-RAN-enabled systems. Data transmission technological increases can include systems that can transmit and process real-time and non-real-time data, deploy data transmission modules at edge computing devices, quickly and adequately generate data transmission modules for edge deployment, enable transmission of O-RAN vendor-generated data using common governance terms, and the like.

Aspects of the present disclosure teach systems and methods that can be used in disaggregated RAN systems (e.g., O-RAN systems) to aid in the low-latency transmission of data between O-RAN components on multiple levels of the telecommunication system. Real-time and near-real-time data communication can enable consumers to identify health and operational concerns with decreased latency, which may be important for telecommunication systems. The increase in data provided by the multiple vendor system can be utilized for increased data capture and more particular health analysis. Using methods and systems defined herein, the increased data can be managed in a scalable way. This technology leverages the use of message buses to provide direct pathways for data. By creating methods and systems to circumvent the need for a central storage, communication channels as described herein can lower financial and time costs, making it a cornerstone technology for next generation (NG) networks (e.g., 5G or 6G networks) and beyond.

Methods and systems to enable the data consumption of an O-RAN system can include, but are not limited to, managed message buses that eliminate the need for permanent or direct communication lines between consumers and producers. By utilizing a message bus, data from one producer can be provided to one or more consumers without the need for additional connections at the producer. Further, using message buses on the system or, for example, on a cloud computing source, message buses are scalable and can handle the increase in data produced by O-RAN components over previous telecommunication system technologies.

Methods and systems can include a controller that can control connections to message buses during data transmission, such that if a message bus experiences a failure, the connection can be quickly reestablished on another message bus. Enabling dynamic connections to a message bus rather than stagnant connections that are hardwired between producers and consumers, the controller can reroute data transmission to prevent any delays in data analysis on the health of telecommunication system based on a communication link failure. Further, methods and systems herein can deploy message buses at all levels of the system, including, but not limited to, the LDC, the RDC, the BEDC, the PEDC, and the like. By enabling message bus deployment on edge systems, the connection between producers and consumers can be more closely tied to the production source and can enable lower latency due to transmission, thus decreasing down time of data consumption and analytics. Message buses deployed at edge systems can be pre-generated message buses selected for the requirements of the edge devices. Having access to pre-generated message buses can decrease the time required to generate and deploy a message bus that meets the requirements of a producer once a producer requests a message bus or is initialized on the system.

With the increase in data generated by the system, and additional and particular sources generating the data from throughout the system, additional topic governance can allow for low latency data transmission and accurate data transmission to consumers. Utilization of topic governance principles can enable consumers to receive all pertinent data quickly and accurately and prevent floods of irrelevant data from being provided from the producer through the message bus to the consumer.

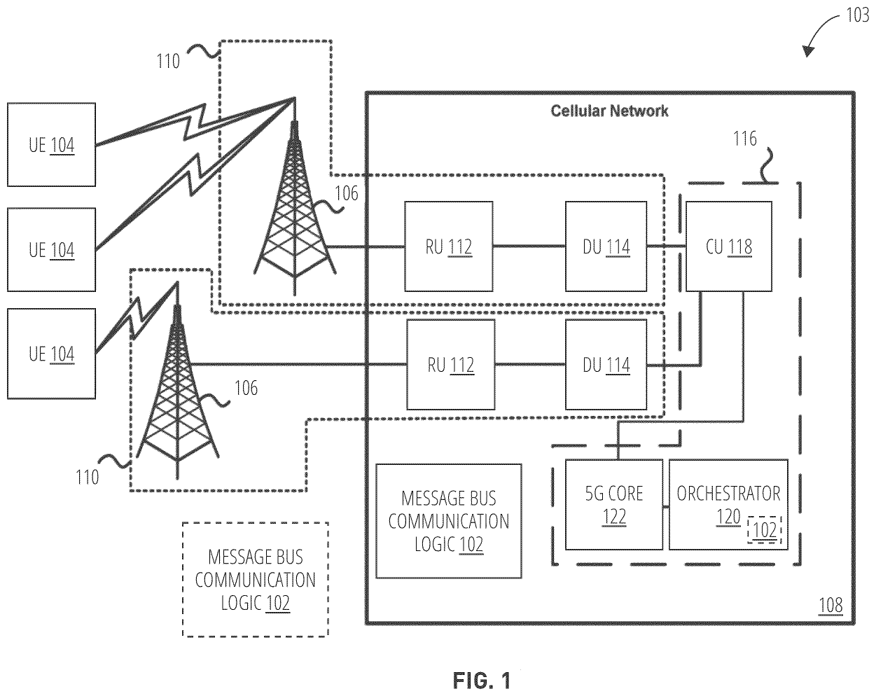

FIG. 1 is a block diagram of a cellular network system 103 (“system 103”) implementing a message bus system in a cellular network, according to at least one embodiment. FIG. 1 represents an embodiment of a cellular network which can accommodate the cloud-based architecture. System 103 can include a 5G New Radio (NR) cellular network; other types of cellular networks, such as 6G, 7G, etc. may also be possible. System 103 can include: UEs 104; base station structure 106 including base station equipment (i.e., base station 110); cellular network 108; radio units 112 (“RUs 112”); distributed units 114 (“DUs 114”); centralized unit 118 (“CU 118”); 5G core 122, and orchestrator 120. FIG. 1 represents a component-level view. In an open radio access network (O-RAN), because components can be implemented as specialized software executed on general-purpose hardware, except for components that need to receive and transmit radio frequency (RF), the functionality of the various components can be shifted among different servers. For at least some components, the hardware may be maintained by a separate cloud-service provider, to accommodate where the functionality of such components is needed.

UE 104 can represent various types of end-user devices, such as cellular phones, smartphones, cellular modems, cellular-enabled computerized devices, sensor devices, gaming devices, access points (APs), any computerized device capable of communicating via a cellular network, etc. Generally, UE can represent any type of device that has an incorporated 5G interface, such as a 5G modem. Examples can include sensor devices, Internet of Things (IoT) devices, manufacturing robots; unmanned aerial (or land-based) vehicles, network-connected vehicles, etc. Depending on their location, individual UEs 104 may use RF to communicate with various base stations in cellular network 108. For example, base station 110 can include a base station structure 106, a radio unit (RU) 112, and a distributed unit (DU) 114. Base station structure 106 may be any structure to which one or more antennas (not illustrated) of the base station are mounted. Base station structure 106 may be a dedicated cellular tower, a building, a water tower, or any other human-made or natural structure to which one or more antennas can reasonably be mounted to provide cellular coverage to a geographic area. Similarly, base station 110 can include: base station structure 106, RU 112, and DU 114.

Real-world implementations of system 103 can include many (e.g., thousands) of base stations and many CUs and 5G core 122. Base station structure 106 can include one or more antennas that allow RUs 112 to communicate wirelessly with UEs 104. RUs 112 can represent an edge of cellular network 108 where data is transitioned to wireless communication. The radio access technology (RAT) used by RU 112 may be 5G New Radio (NR), or some other RAT. The remainder of cellular network 108 may be based on an exclusive 5G architecture, a hybrid 4G/5G architecture, a 4G architecture, or some other cellular network architecture. Base station 110 may include an RU 112 and a DU 114.

One or more RUs 112 may communicate with DU 114. As an example, at a possible cell site, three RUs may be present, each connected with the same DU. Different RUs may be present for different portions of the spectrum. For instance, a first RU may operate on the spectrum in the Citizens Broadcast Radio Service (CBRS) band while a second RU may operate on a separate portion of the spectrum, such as, for example, band 71. One or more DUs 114 may communicate with CU 118. Collectively, an RU, DU, and CU create a gNodeB, which serves as the radio access network (RAN) of cellular network 108. CU 118 can communicate with 5G core 122. The specific architecture of cellular network 108 can vary by embodiment. Edge cloud server systems outside of cellular network 108 may communicate, either directly, via the Internet, or via some other network, with components of cellular network 108. For example, DU 114 may be able to communicate with an edge cloud server system without routing data through CU 118 or 5G core 122. Other DUs may or may not have this capability.

While FIG. 1 illustrates various components of cellular network 108, other embodiments of cellular network 108 can vary the arrangement, communication paths, and specific components of cellular network 108. While RU 112 may include specialized radio access componentry to enable wireless communication with UE 104, other components of cellular network 108 may be implemented using either specialized hardware, specialized firmware, and/or specialized software executed on a general-purpose server system. In an O-RAN arrangement, specialized software on general-purpose hardware may be used to perform the functions of components such as DU 114, CU 118, and 5G core 122. Functionality of such components can be co-located or located at disparate physical server systems. For example, certain components of 5G core 122 may be co-located with components of CU 118.

In a possible virtualized O-RAN implementation, CU 118, 5G core 122, and/or orchestrator 120 can be implemented virtually as software being executed by general-purpose computing equipment, such as in a data center of a cloud-computing platform, as detailed herein. Therefore, depending on needs, the functionality of a CU, and/or 5G core may be implemented locally to each other and/or specific functions of any given component can be performed by physically separated server systems (e.g., at different server farms). For example, some functions of a CU may be located at a same server facility as where the DU is executed, while other functions are executed at a separate server system. In the illustrated embodiment of system 103, cloud-based cellular network components 116 include CU 118, 5G core 122, and orchestrator 120. Such cloud-based cellular network components 116 may be executed as specialized software executed by underlying general-purpose computer servers. Cloud-based cellular network components 116 may be executed on a third-party cloud-based computing platform or a cloud-based computing platform operated by the same entity that operates the RAN. A cloud-based computing platform may have the ability to devote additional hardware resources to cloud-based cellular network components 116 or implement additional instances of such components when requested.

Kubernetes, or some other container orchestration platform, can be used to create and destroy the logical CU or 5G core units and subunits as needed for the cellular network 108 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. (Rather, processing and storage capabilities of the data center would be devoted to the needed functions.) When the need for the logical CU or subcomponents of the CU no longer exists, Kubernetes can allow for removal of the logical CU. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 120. Orchestrator 120 can represent various software processes executed by underlying computer hardware. Orchestrator 120 can monitor cellular network 108 and determine the amount and location at which cellular network functions should be deployed to meet or attempt to meet service level agreements (SLAs) across slices of the cellular network.

Orchestrator 120 can allow for the instantiation of new cloud-based components of cellular network 108. As an example, to instantiate a new core function, orchestrator cellular network 108 can perform a pipeline of calling the core function code from a software repository incorporated as part of, or separate from, cellular network 108; pulling corresponding configuration files (e.g., helm charts); creating Kubernetes nodes/pods; loading the related core function containers; configuring the core function; and activating other support functions (e.g., Prometheus, instances/connections to test tools).

A network slice functions as a virtual network operating on cellular network 108. Cellular network 108 is shared with some number of other network slices, such as hundreds or thousands of network slices. Communication bandwidth and computing resources of the underlying physical network can be reserved for individual network slices, thus allowing the individual network slices to reliably meet defined SLA parameters. By controlling the location and amount of computing and communication resources allocated to a network slice, the quality of service (QoS) and quality of experience (QoE) for UE can be varied on different slices. A network slice can be configured to provide sufficient resources for a particular application to be properly executed and delivered (e.g., gaming services, video services, voice services, location services, sensor reporting services, data services, etc.). However, resources are not infinite, so allocation of an excess of resources to a particular UE group and/or application may be desired to be avoided. Further, a cost may be attached to cellular slices: the greater the amount of resources dedicated, the greater the cost to the user; thus, optimization between performance and cost is desirable.

Particular network slices may only be reserved in particular geographic regions. For instance, a first set of network slices may be present at RU 112 and DU 114, a second set of network slices, which may only partially overlap or may be wholly different from the first set, may be reserved at the other RU 112 and DU 114.

Further, particular cellular network slices may include some number of defined layers. Each layer within a network slice may be used to define QoS parameters and other network configurations for particular types of data. For instance, high-priority data sent by a UE may be mapped to a layer having relatively higher QoS parameters and network configurations than lower-priority data sent by the UE that is mapped to a second layer having relatively less stringent QoS parameters and different network configurations.

Components such as DUs 114, CU 118, orchestrator 120, and 5G core 122 may include various software components that are required to communicate with each other, handle large volumes of data traffic, and are able to properly respond to changes in the network. In order to ensure not only the functionality and interoperability of such components, but also the ability to respond to changing network conditions and the ability to meet or perform above vendor specifications, significant testing must be performed.

5G core 122, which can be physically distributed across data centers or located at a central national data center (NDC), can perform various core functions of the cellular network. 5G core 122 can include: network resource management components; policy management components; subscriber management components; and packet control components. Individual components may communicate on a bus, thus allowing various components of 5G core 122 to communicate with each other directly. 5G core 122 is simplified to show some key components. Implementations can involve additional other components.

Network resource management components can include network repository function (NRF) and network slice selection function (NSSF). NRF can allow 5G network functions (NFs) to register and discover each other via a standards-based application programming interface (API). NSSF can be used by access and mobility management function (AMF) to assist with the selection of a network slice that will serve a particular UE.

Policy management components can include charging function (CHF) and policy control function (PCF). CHF allows charging services to be offered to authorized network functions. Converged online and offline charging can be supported. PCF allows for policy control functions and the related 5G signaling interfaces to be supported.

Subscriber management components can include unified data management (UDM) and authentication server function (AUSF). UDM can allow for generation of authentication vectors, user identification handling, NF registration management, and retrieval of UE individual subscription data for slice selection. AUSF performs authentication with UE.

Packet control components can include access and mobility management function (AMF) and session management function (SMF). AMF can receive connection- and session-related information from UE and is responsible for handling connection and mobility management tasks. SMF is responsible for interacting with the decoupled data plane, creating, updating, and removing protocol data unit (PDU) sessions, and managing session context with the user plane function (UPF).

User plane function (UPF) can be responsible for packet routing and forwarding, packet inspection, QoS handling, and external PDU sessions for interconnecting with a data network (DN) (e.g., the Internet) or various access networks. Access networks can include the RAN of cellular network 108.

5G core 122 may reside on a cloud computing platform. While from a client's or user's point of view, the “cloud” can be envisioned as an ephemeral computing workspace that occupies no physical space, in reality, a cloud computing platform is an interconnected group of data centers throughout which computing and storage resources are spread. Therefore, data centers may be scattered geographically and can provide redundancy. As used herein, “client” may refer to an end system or device working autonomously or at the direction of a user. A client may be, for example, a client device, user terminal, cloud service subscriber, etc. A client may be a data producer or a data consumer for telecommunication network data. A data producer may comprise one or more O-RAN components producing data. A data producer may comprise one or more O-RAN components that produce data, which may be considered a client either individually or as a group. A client may be storage within a cloud computing environment.

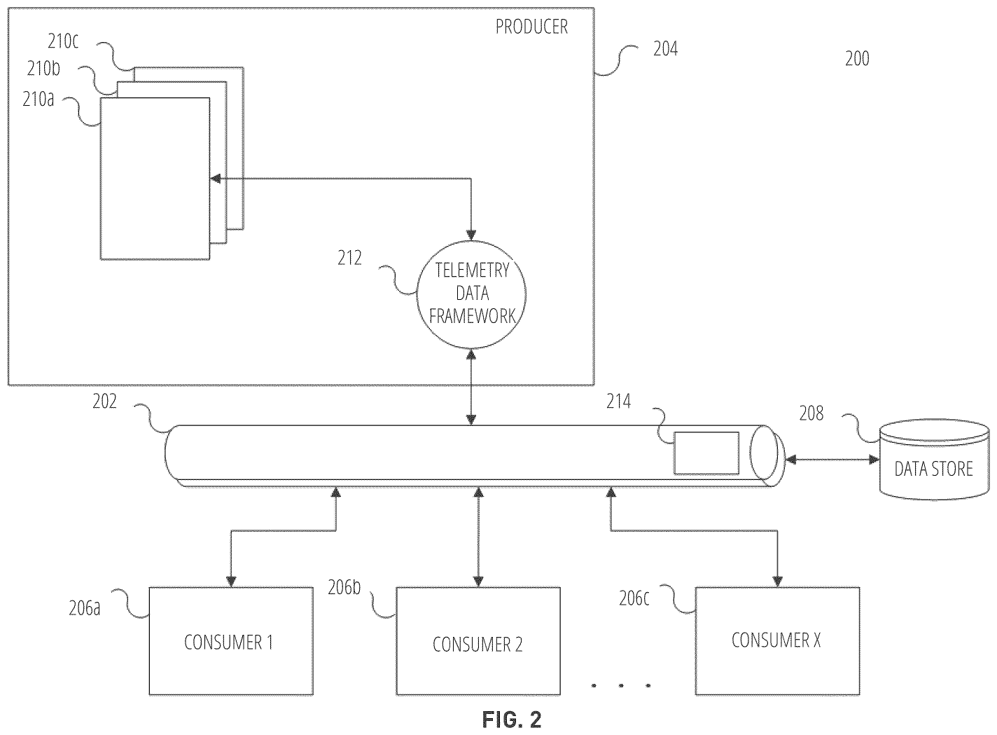

As illustrated below in FIGS. 2-7, the system 103 includes the message bus communication logic 102 as described above with respect to FIG. 2 to FIG. 7. In some embodiments, the system 103 can be a next generation telecommunication system such as, for example, 5G, 6G, and the like. Within next generation systems, data producers such as RUs 112, DUs 114, CUs 118, and the like can be multi-vendor components that can generate more usable data for data consumption than traditional telecommunication system components. To manage communication of the large amounts of data of next generation telecommunication systems, the system 103 may implement the message bus communication logic 102 to facilitate the flow of data from the O-RAN data producers and data consumers. The message bus communication logic 102 can be part of a data platform, which is a system or a suite of tools technologies designed to communicate, manage, store, process, analyze, and/or visualize large volumes of data generated by the system 103. The data platform can be used by modern data-driven organizations, enabling them to harness the power of their data for various purposes, such as business intelligence, analytics, machine learning, and more. In general, the data platform includes components for data ingestion, data storage, data processing, data management, data integration, data analytics, machine learning (ML) and artificial intelligence (AI) platforms, data security, or the like. For example, a data ingestion component can use extract, transform, load (ETL) logic (tools or processes) that extract data from various sources, transform it into a suitable format, and load it into a storage system. The data ingestion component can be set up to stream real-time data from sources, such as Internet of Things (IoT) devices, transactional systems, or other network functions. The data platform can include data storage components, such as data lakes, data warehouses, and database systems. Data lakes are large storage repositories that hold raw data in its native format until it is needed. Data warehouses are structured storage systems optimized for query performance and analytics, often storing cleaned and processed data. Database systems can include both relational (e.g., SQL) and non-relational (e.g., NoSQL) databases for various data storage needs. The data processing components can handle batch processing, streaming processing, or the like. Batch processing can handle large volumes of data in batches, typically for tasks like reporting, data transformation, and aggregation. Stream processing can handle real-time processing of continuous data streams to support applications like real-time analytics and monitoring. Data management components can handle metadata management and data governance. The metadata management can include tools for managing metadata, which is data about data, including data catalogs, lineage, and governance. Data governance can include policies and processes to ensure data quality, security, privacy, and compliance with regulations. Data integration components can provide application programming interfaces (APIs), data virtualization, etc. The APIs can be used for accessing and integrating data across different systems. Data virtualization techniques can be used for abstracting and integrating data from various sources without moving it physically. The data analytics components can have Business Intelligence (BI) and advanced analytics tools and platforms for data reporting, visualization, and dashboards to support decision-making. Advanced analytics techniques, like data mining, predictive analytics, and statistical analysis, can be used to derive deeper insights. The ML/AI platforms can provide a model training platform for developing and training machine learning models using data stored in the platform, and a model deployment platform for deploying trained models into production environments for real-time or batch inference. Data security components can provide access control, encryption, etc. Access control mechanisms can be used for ensuring that only authorized users can access specific data. Encryption techniques can be used for protecting data both at rest and in transit to prevent unauthorized access and breaches. The data platform can consolidate data from various sources into a single platform, making it easier to manage and access. The data platform can support large-scale data storage and processing, accommodating growing data volumes and increasing complexity. The data platform can enable real-time data processing and analytics, allowing organizations to respond quickly to changing conditions. The data platform can facilitate collaboration across different departments and teams by providing a unified data environment. The data platform can implement data governance and quality control measures to ensure the accuracy and reliability of data. The data platform can provide the infrastructure, tools, and insights organizations need to manage, process, and analyze data effectively, enabling them to make informed decisions and unlock the full potential of their data assets. The data platform can also provide business intelligence and reporting. The data platform can aggregate data from multiple sources to generate comprehensive reports and dashboards for business analysis. The data platform can provide real-time analytics. In particular, the data platform can monitor and analyze data streams in real-time to gain immediate insights and drive instant actions. The data platform can provide customer insights by analyzing customer data to understand behavior patterns, preferences, and trends to improve customer experience and loyalty. The data platform can implement predictive maintenance as well, such as using machine learning models to predict equipment failures and schedule proactive maintenance in industries like manufacturing and utilities.

FIG. 2 is a block diagram of a system 200 implementing one or more message buses 202 within a cellular network according to at least one embodiment. FIG. 1 represents an embodiment of a cellular network that can facilitate real-time and non-real-time message bus data transmission in next generation data transmission technologies. The cellular network 108 can be a next generation cellular network that is configured for next generation transmissions of data. System 200 can include one or more message buses 202, one or more producers 204, one or more consumers 206, and a data store 208. The system can be configured as a 5G New Radio (NR) cellular network; or other types of cellular networks, such as 6G, 7G, etc. In some embodiments, producers 204 can include UEs 104, RUs 112, DUs, CUs 118, and the like. Consumers may include UEs 104, RUs 112, DUs 114, CUs 118, and systems and devices external to the cellular network 108. In some embodiments, the message bus 202 may be located either within the cellular network 108 (for example, as part of the message bus communication logic 102) or external to it.

The message bus 202 is a communication mechanism that facilitates the transfer of data from producers 204 to consumers 206. In some embodiments, communication mechanisms may be an existing wired connection connecting producers 204 and consumers 206. However, the RU 112 may not be directly hardwired to the CU 118. Using a message bus 202, there is no need for a hardwired connection between any one or more producers 204 to any one or more consumers 206. Using the message bus 202 can prevent the need for hardwired connections, which can introduce delays due to indirect routing. During transmission of data through a message bus 202, the message bus 202 may be associated with one or more short-term data stores 214. The data may be temporarily stored within the short-term data stores 214 associated with the message bus 202 transmitting the data. The data may be transmitted by the message bus 202 from the short-term data stores 214 to the data store 208 or directly to the consumer 206.

Further, using message buses 202, data may be segmented and provided to select consumers 206 that can utilize the data rather than passing all data through potentially a single pathway. For example, passing a portion of data from the RU 112 to the DU 114 and passing a portion of data from the RU 112 to the CU 118 through the DU 114 using the same pathways as the first portion of data. In some embodiments, only specific portions of data from one or more producers 204 may be provided to one or more consumers 206, depending on the consumers' data usage requirements. For example, consumer 206a may be a consumer configured to maintain a comprehensive and accurate record of the network's physical and logical components. In a complex system, the consumer 206a may be dedicated to a certain aspect of the network. Therefore, the consumer 206a may not require all data produced by the producers 204, or even all data from any one producer 204.

In some embodiments, message bus 202 may be configured to receive and interpret requests for data transmission from the consumers 206. The requests may instruct the message bus 202 on the type of data that is expected, usable, and/or required by the consumer 206. For example, the requests may specify the type of data the consumer 206 needs and the producers 204 from which the data should be sourced. Additional identifiers may also be used by the message bus 202 to ensure the consumer 206 receives the desired data.”

A type of data may include, but may not be limited to, service configuration data, sensor data, network performance data, machine data, video and image data, geospatial and location data, telemetry data, event and log data, artificial intelligence and machine learning data, storage data, diagnostic data, control data, etc. For example, if a consumer 206b is configured to use data to optimize network services, the consumer 206b may require topological data and service configuration data for data producers 204. Upon connection to the system 200, the consumer 206b may provide standing requests to the message bus 202 to provide all topological data and service configuration data to the consumer 206b. In some embodiments, multiple consumers configured to optimize network services may be connected to the system 200 to optimize network services in different geographical areas. In such embodiments, the consumers may require data only from producers 204 in that geographical area. The requests provided to the message bus 202 may indicate the geographical area associated with the desired data, thereby enabling the message bus 202 direct geographically appropriate data to the requested consumers 206.

In some embodiments, the requests to the message bus 202 may occur when the consumer 206 determines a need for the information. For example, if consumer 206a is configured to update records for producers 204, the records maintained at the consumer 206, at a designated period, the consumer 206a may request updated data at that period. In some embodiments, the message bus 202 may provide the retrieval requests to all producers 204 within the system 200. In some embodiments, the message bus 202 can utilize one or more producer identifiers within the retrieval requests from the consumer 206 and provide the retrieval requests to one or more producers 204 associated with the identifiers.

In some embodiments, the consumer 206 may not be aware of the producers 204 connected to the system. In such embodiments, the consumer 206 may provide retrieval requests to retrieve data of a certain type from the producers 204. The retrieval requests may be sent by the message bus 202 to all producers 204 indiscriminately to provide the information associated with the type. In some embodiments, the message bus 202 may provide the retrieval requests to the producers 204 known to the message bus to generate data of the type.

In some embodiments, a producer 204 can produce one or more types of data, for example within the producer 204 at sub-producers 210. Sub-producers 210 may be components configured to capture a type of data. For example, a sub-producer 210a may be a temperature sensor on the producer 204 determining the operating temperature. Sub-producer 210b may be a geolocation component that determines location data of the producer 204. In some embodiments, the sub-producers 210 may be configured to generate and provide data directly to the message bus 202. In some embodiments, the sub-producers 210 can send data to a telemetry data framework 212 prior to providing the data to the message bus 202. The telemetry data framework 212 can collect, manage, and process telemetry data. The framework may receive raw data from the sub-producers 210, interpret and label it, and prepare it for use outside the producer 204. Each sub-producer 210 may be associated with a sub-producer identifier.

In some embodiments, the producer 204 may provide information to the message bus 202 during connection to the system 200. The producer 204 may indicate one or more data types produced by the producer 204, an amount of data production, the presence of sub-producers 210, a sub-producer identifier, etc., that the message bus 202 may be required to transmit to consumers 206. For example, if a sub-producer 210c, like sub-producer 210a, is a temperature sensor at a different location of the producer 204, the message bus 202 may be required to keep temperature data separated based on the production source rather than group the data all into a single data type, for example, “temperature”. In some embodiments, the message bus 202 may use the predicted data amount provided to the message bus 202. The predicted data amount may be used to assign the output from a producer 204 (or a sub-producer 210 within the producer 204) to multiple message buses 202 to handle the data transmissions.

In some embodiments, a producer 204 may be located in a specific geolocation that can be classified as a region. Different data analysis on regions may be required for diagnosing or otherwise monitoring health and operation of a radio access network. To preserve regions and associated data, the producers 204 may include region identifiers as part of data description.

In some embodiments, the message bus 202 can receive information from producers 204 and requests from consumers 206, and can determine which message buses 202 to use to connect the relevant producers and to consumers that will utilize the data. The message buses 202 may act as non-permanent data transmission lines. Without needing to be provided to a large data store, the data can pass much more quickly to the consumer 206, providing real-time data communication. Additionally, the lack of direct producer 204 to consumer 206 data communication lines can allow for flexibility and redundancy of data interpretation and consumption. “Consumers 206 can be granted or denied access to producer 204 data as needed, without requiring changes to the physical components of system 200.

In some embodiments, the message buses 202 can provide data to the data store 208 for temporary storage if the data is not required immediately, or in a timely manner, by a consumer 206, but may be required in the near future. In some embodiments, the data may be stored for a finite amount of time, such as three days. Such data store usage can enable non-real-time data communication alongside the real-time data communication. The data provided to the data store 208 can be adjusted based on the requests provided by the consumers 206. For example, if a new consumer is initialized onto the system and requests a type of data that has previously been used sparingly such that it is directed to the data store 208 until specifically requested, the data may be directed to the consumer 206, bypassing the data store 208 entirely. In some embodiments, an administrator or preset instructions can direct the message buses 202 on what data to provide to the data store 208 in addition to, or in lieu of, consumer requests.

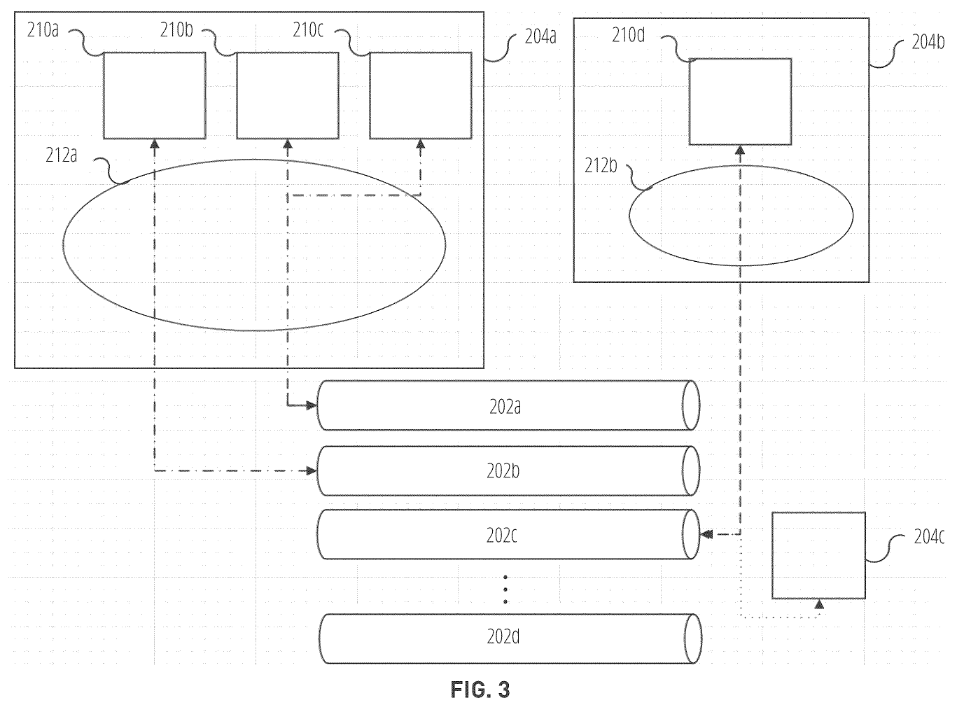

FIG. 3 shows one or more producers 204 utilizing one or more message buses 202 within the cellular network 108, according to at least one embodiment. As described in FIG. 1, in some embodiments, the system 200 may utilize one or more message buses 202 to connect to producers 204 within the system 200. In some embodiments, one or more producers 204 can be connected to one or more message buses 202 based on predicted or real data output volume of the producer 204.

FIG. 3 shows a first producer 204a with three sub-producers 210a-210c. The sub-producers 210a-210c are configured as Open Radio Access Network (O-RAN) components such as the RUs 112, DUs 114, and CU 118 of FIG. 1. O-RAN components can include architectures and/or components disaggregated across a radio access network that enable functionality of one or more edge devices of a telecommunication system. For example, O-RAN components can interact with and be hosted in distribution centers including, but not limited to, a RAN distributed center (RDC), a local distributed center (LDC), a backhaul edge distributed center (BEDC), and/or a public edge distributed center (PEDC). The RDC, LDC, BEDC, and PEDC can be different levels of abstraction between edge devices. For example, the RDC may be deployed closer to an edge device without direct interaction, while an LDC may interact directly with an edge device. As described within, O-RAN components stored in the edge distribution centers may be producers or consumers, therefore edge devices may be referred to as “producers” or “consumers” based on the components within.

In O-RAN architecture, RU 112, DU 114, and CU 118 are designed to be disaggregated and modular, providing flexibility and scalability across the network. These components are closely integrated with various network deployment models like LDC, RDC, BEDC, PEDC, and others, which support the physical and virtual network functions in an efficient manner. The LDC is located near the network edge and can host the DU, which is responsible for real-time processing tasks such as radio signal transmission, user plane management, and lower-layer processing. By placing the DU 114 in the LDC, O-RAN ensures that latency-sensitive operations, such as user data handling, are performed closer to the end users, minimizing delays and improving the overall quality of service for applications like mobile broadband.

In contrast, the RDC is typically located further away from the edge, serving as a centralized location for the CU 118. The CU 118 handles higher-layer functions such as scheduling, mobility management, and radio resource management, which require coordination across multiple DUs 114 and are less time-sensitive than tasks performed by the DU 114. The RDC provides the necessary computing resources to manage these tasks on a larger scale, allowing for more centralized control while still maintaining network flexibility and scalability. The CU 118 in the RDC is connected to the DU 114 in the LDC through high-speed, low-latency links, ensuring seamless communication between the disaggregated components.

The BEDC can be responsible for hosting the baseband processing functions that are part of the DU 114 and CU 118. The BEDC is often deployed in a more centralized location, as it supports the aggregation of multiple DUs and provides centralized control and processing for resource management and coordination across a large geographical area. The BEDC ensures that higher-layer processing, such as scheduling, mobility management, and user plane functions, is handled efficiently, often in coordination with the CU 118, which may be located in an RDC. By deploying baseband processing functions in the BEDC, operators can streamline operations and provide network-wide management of traffic and resources without having to deploy baseband equipment directly at each cell site.

On the other hand, the PEDC is located closer to the network edge, typically in proximity to the users. The PEDC can host the DU 114 and supports low-latency, real-time operations that are required for tasks such as radio resource management, real-time traffic handling, and user plane processing. Placing the DU 114 in the PEDC ensures that latency-sensitive operations, such as voice calls, video streaming, and interactive applications, are processed as close to the user as possible, minimizing delays and improving the user experience. The PEDC can also serve as an aggregation point for multiple cell sites, providing the necessary resources for managing traffic across a larger area, but still maintaining low latency for edge applications.

O-RAN components can be components that produce data within next generation data communication systems (e.g., 5G, 6G, and the like). O-RAN components allow for functionalities within a telecommunication system to be executed using multiple vendors. For example, the first sub-producer 210a may be receiving data provided by a first vendor and the second and third sub-producers 210b-210c may be receiving data provided by a second vendor. The first vendor and the second vendor may produce overlapping data and, in some embodiments, may have varied scopes of data production and capture. Using a multi-vendor ecosystem, the producer 204 may produce more data than would be allowed in a single-vendor ecosystem.

Further, data production in producers that utilize O-RAN components can include components at multiple levels of hierarchy (e.g., at the RDC, LDC, BEDC, PEDC, and the like). In some embodiments, data is produced at each level of the hierarchy. The data can be redundant between levels or can be directed to data regarding the specifics of the level, thereby creating more data than non-O-RAN systems. For example, producer 204a may be one or more edge devices that utilize O-RAN producers 210a-210c at various levels of hierarchy. Such additional productions of data could overwhelm a central data store, or may require a high-capacity data store, or multiple data stores. Such accommodations in a central data store may be costly in both storage space and operating costs. In embodiments where the sub-producers 210 are O-RAN components, such as in producer 1 204a, the telemetry data framework 212a may be used to accept data from multiple levels of abstraction that are generated by multiple vendors and normalize the data into an expected data output format.

Decentralization of the O-RAN components results in the generation of a wide variety of data that is critical for analyzing the health and operation of the telecom network. These data types can be utilized to monitor network performance, optimize operations, and predict potential issues. Performance metrics such as received signal strength, signal-to-noise ratio, reference signal received power, and reference signal received quality can be used to determine the health and efficacy of components within the system. These performance indicators are essential for diagnosing coverage issues, interference, or areas where signal strength is insufficient, thus helping network operators optimize network placement and improve user experience in challenging environments.

Traffic and throughput data can be used to track the volume of data being transmitted and received across the network. This includes metrics like downlink and uplink throughput, packet data traffic, and data volume per user. Such data is essential for monitoring network congestion and capacity, ensuring that the network can handle increasing data demand, especially during peak usage times. Analyzing traffic data helps operators identify congestion points, underutilized resources, and areas that may require network upgrades, as well as plan for optimal resource allocation and traffic management.

Quality of Service (QoS) metrics are also crucial for assessing network health, particularly for latency-sensitive applications. Data on latency, including round-trip time (RTT), packet loss, and jitter, is used to measure the responsiveness and reliability of the network. High latency or jitter can significantly affect user experience, particularly for real-time applications like video conferencing or VoIP. Tracking QoS metrics enables operators to maintain the network's performance by addressing issues that may affect critical applications and ensuring that latency-sensitive services receive appropriate priority.

Fault and alarm data are other critical data sources for analyzing network health. These alarms indicate when network elements, such as the RU 112, DU 114, or CU 118, experience operational failures or degraded performance. Alarm data can include information about hardware malfunctions, link failures between RAN components, or service interruptions that affect the quality of the user experience.

Mobility and handover data provide valuable insights into how users are moving across the network and how well the network is handling handovers between cells. Metrics such as handover success rate, handover failure reasons, and cell reselection data help operators understand the performance of mobility management and the ability of the network to seamlessly support users as they move between different coverage areas. Analyzing mobility data aids in optimizing handover processes, preventing service interruptions, and ensuring that users receive a smooth experience when transitioning between cells, particularly in high-traffic or dense urban environments.

In some embodiments, for example, when O-RAN sub-producers 210a-210c are producing more data than can be handled by a message bus 202 of a certain size, the system 200 may allocate multiple message buses 202a-202b to the producer 204a. As depicted, O-RAN producer 1 210a may produce enough data to require a dedicated message bus 202b. O-RAN producers 2 and 3 210b-210c may be combined into one message bus 202a. Upon configuration of the producer 204a into the system 200, the producer 204a may provide expected data yields per sub-producer 210a-210c. The system 200 can then establish connections to the respective message buses 202a-202b to handle the predicted capacity. The telemetry data framework 212a may be provided an indication of the message bus 202 to be provided data from each sub-producer 210 and may be responsible for configuring the data to allow for proper message bus 202 transmission. In some embodiments, the message bus 202 can use the sub-producer identifiers to retrieve data from a telemetry data framework 212 after the data has been normalized by the framework.

In some embodiments, proper message bus 202 transmission can be executed by including an identifier of the source to the system 200 with the data. Thus, the data tagged by the telemetry data framework 212a will be provided to the proper message bus 202 by the system 200. In some embodiments, the telemetry data framework 212 is connected to all message buses 202 utilized by the producer 204a and provides data from the O-RAN Producer 1 210a to the message bus 202b and the data from the O-RAN Producers 2 and 3 210b-c to the message bus 202a after processing the data.

In some embodiments, one or more producers can share a message bus 202c. As previously stated above, a producer 204b can utilize one or more O-RAN components, for example O-RAN producer 210d to generate additional data using a multi-vendor ecosystem. The O-RAN component, such as producer 210d, may produce the data in a first format. The telemetry data framework 212b may normalize the data into a second format. The third producer 204c may, in some embodiments, be a data producer that may or may not utilize O-RAN components. The data from the producer 204c may be produced and may be provided directly to the assigned message bus 202c. As the message bus 202c is configured to accept data from multiple producers 204b and 204c, the data output to the message bus 202c may need to be of a same data format. In some embodiments, the message bus 202c may be configured to receive and transmit data in multiple formats.

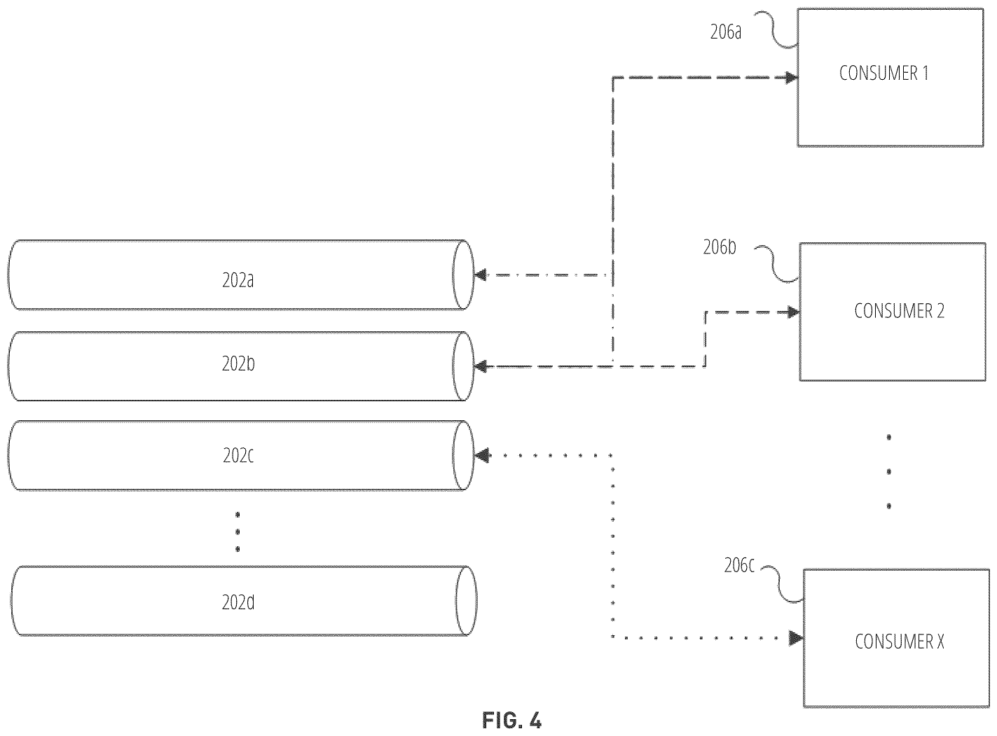

FIG. 4 shows one or more consumers 206 utilizing one or more message buses 202 within the system 103 according to at least one embodiment. As described in FIG. 1, in some embodiments, the system 200 may utilize one or more message buses 202 to connect to consumers 206 within the system 200. In some embodiments, a connection between a consumer 206 and a message bus 202 is determined based on the data required and/or requested by the consumer 206. In some embodiments, upon configuration of a consumer 206 within the system 200, the consumer provides retrieval requests to the system 200 to allow the system to connect the consumer 206 to the message bus 202 that will allow transmission of the requested data from a producer 204. For example, a consumer 206 may be configured as an orchestration platform for a slice of a data communication system. An orchestration platform may, in some embodiments, use data associated with the slice, such as according to a geographic region, to automate service provisioning and network performance management. The data required may include operational data from multiple components within the producer 204. The retrieval request as part of the configuration of the consumer 206 may provide the geolocation associated with the slice such that the message buses 202 in data communication with the consumer 206 will receive data from producers 204 associated with the geolocation.

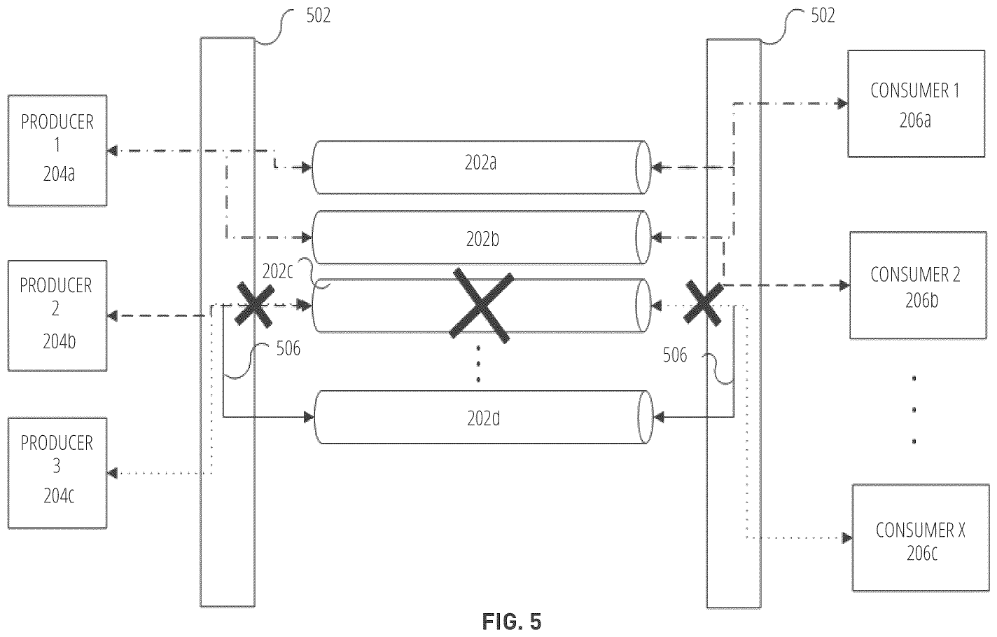

In some embodiments, a request for integration into the system 200 will be fielded by a user of the system 200 that can manually assign the producers 204 and consumers 206 to message buses 202. In some embodiments, based on the configuration information provided by the consumer 206 and/or the producer 204, the message buses 202 will be assigned automatically by the system 200, for example, at a central controller. More discussion on a central controller can be found in the discussion of FIG. 5 below.

FIG. 4 shows a first consumer 206a receiving data from a first message bus 202a and a second message bus 202b. As described in FIG. 3, data from a single producer 204a can be transmitted using multiple message buses 202a and 202b. Consumer 1 206a may be a consumer that requires all of the data from a single producer 204a. In some embodiments, Consumer 1 206a may require a portion of the data provided to each message bus 202a and 202b. Thus, the consumer 206a is connected to the message buses 202a and 202b that connect with the producer 204a. Consumer 2 206b may not require all the data produced by producer 1 204a, but rather may only require the data produced at the O-RAN sub-producer 210a. Thus, producer 2 is not connected to any message bus 202 other than message bus 2 202b.

FIG. 5 shows central controller 502 utilized for smart connection of one or more producers 204 to one or more consumers 206, according to at least one embodiment. The central controller 502 is depicted as being two distinct pieces but instead can be a central controller that is able to access and configure connections between message buses 202, producers 204, and consumers 206. As mentioned above, a central controller 502 can be stored within the message bus communication logic 102 and can be utilized to automatically configure the traffic to and from the message buses 202 of the system 200. In some embodiments, the central controller 502 accepts the configuration requests from both the producers 204 and the consumers 206 and assigns the producers 204 and consumers 206 to message buses 202 as described above. In some embodiments, the central controller 502 may further manage faults within the system 200. In some embodiments, the central controller 502 may include a processing unit and a memory storing one or more executable instructions that cause the central controller 502 to enable communication channels between the producers 204, consumers 206, and message buses 202.

As shown in FIG. 2 and FIG. 4, a first producer 204a may be configured by the central controller 502 to provide data to message buses 202a and 202b, a second producer 204b and a third producer 204c may be configured by the central controller 502 to provide data to message bus 202c. Similarly, the central controller 502 may configure Consumer 1 206a to retrieve data from message buses 202a and 202b, Consumer 2 206b from message bus 202b, and a third consumer 206c from message bus 202c.

In some embodiments, after configuring the system 500, the central controller 502 may be inactive until a subsequent configuration request to add a producer 204 and/or a consumer 206 is provided to the system 500. At that time, the central controller 502 can identify and provision proper access through message buses 202 for the newly configured component.

In some embodiments, the central controller 502 can monitor and mitigate connection faults within the system 500. Monitoring and mitigation can include the central controller 502 monitoring and reviewing logging systems that track the health and performance of network connectivity, brokers, message delivery, and system resources. Additionally, the central controller 502 can utilize alerting mechanisms and heartbeat checks to help identify issues such as message loss, duplication, timeouts, and resource exhaustion in real-time.

In a message bus system, various faults can arise, affecting its reliability and performance. Network connectivity failures may disrupt message delivery due to issues such as packet loss or intermittent connections between nodes. Broker failures, such as crashes or unresponsiveness, can halt message processing, impacting communication between producers and consumers. Message loss can occur if messages are dropped during transmission or are not properly acknowledged. Message duplication may result when a message is delivered multiple times, leading to redundant processing by consumers. Data corruption can affect message integrity during transmission or storage, causing incorrect data delivery. Queue overflows or underflows may occur when message queues exceed capacity or are underutilized, disrupting the flow of messages. Timeouts and latency issues can delay message delivery, causing operational disruptions. Authorization and authentication failures may prevent proper access control, leading to rejected connections or messages. Configuration errors can result from improper settings that misroute messages or prevent successful processing. Resource exhaustion, such as running out of memory or disk space, can cause the system to fail to process messages. Topic/queue saturation may occur when a particular topic or queue becomes overloaded, hindering message distribution. Finally, broker synchronization issues can lead to data inconsistencies across distributed brokers, disrupting message processing.

As shown, for example, message bus 202c may have experienced a fault preventing transmission of all data that was being provided from the producers 204b and 204c to consumer 206c. The central controller 502, in some embodiments, upon detecting the fault, may alter communication pathways to reestablish the connection. As shown, the producers 204b and 204c are rerouted 506 to provide data to message bus X 202d. In some embodiments, the central controller 502 selects a message bus to reroute the communication pathway through based on available transmission capacity of message buses in the system. The available transmission capacity can be compared with a transmission through put of the original message bus to ensure the new message bus can support the transmission throughput.

To retrieve the data, the third consumer 206c is rerouted 504 to message bus 202d to receive the data. To enable the connection, the central controller 502 may utilize existing message buses that may already be connecting producers and consumers or may provision and/or utilize an additional message bus. Utilizing existing message buses may include providing requests to the producer and consumer to connect to the alternate message bus for data that was previously transmitted through the faulty message bus. To connect a data producer or consumer to a message bus, the system may be configured with appropriate network connectivity and credentials to authenticate and authorize access. Additionally, the producer or consumer may implement the correct message protocols and serialization formats supported by the message bus for proper message formatting and communication. In some embodiments, the central controller 502 may be required to generate a new message bus and redeploy the message bus and/or connections to the producer and consumer.

In some embodiments, while reestablishing a connection to the producer, the central controller may provide the data from the producers 204b and 204c to the data store to be maintained until the consumer is ready to be supplied data through a message bus. In some embodiments, a central controller may utilize artificial intelligence and/or machine learning to predict data production of producers to better allocate message bus capabilities. For example, should a producer not produce as much data as initially predicted, the central controller may add additional producers to a previously dedicated message bus.

In some embodiments, the central controller 502 is configured to receive the configuration request from the producers 204 or the consumers 206. The central controller 502 may utilize protocols to authenticate the source of the request as a valid source. In some embodiments, a request may be input into the system 500 using a web-based application that requires log-in credentials to make the request for the user device. The central controller 502 may utilize the log-in credentials and authentication data logs to ensure the request is valid. In some embodiments, the central controller 502 will initiate handshake protocols, token generation, session-based authentication, mutual authentication via pre-shared keys, public key infrastructures, and the like to authenticate the request. More specifically, network connectivity can be established using TCP/IP or other communication protocols, enabling the producer and/or consumer to connect to the message bus over the network. Authentication and authorization can be handled through mechanisms like API keys, OAuth, or certificates, ensuring only authorized entities can publish or consume messages. Message protocols can define the structure of the data exchanged, while serialization and deserialization processes ensure that the data is correctly formatted and interpretable by both the producer and consumer.

In some embodiments, following the receipt of the request, the central controller 502 may parse the request for relevant data to configure the connection. In some embodiments, as described below, the request may be made via a web-based application such that the request is provided to the central controller 502 in an expected format. In some embodiments, the request may be provided to the central controller 502 in an alternative format, such that the central controller 502 may identify the relevant information from within the request. In some embodiments, parsing the request can include utilizing machine learning, such as large language models, to analyze the request. For example, a large language model (LLM) can parse a request by first tokenizing the input text into smaller units (tokens) to understand its structure. It can then apply deep learning algorithms to map the tokens to their semantic meaning, recognizing intent, entities, and relationships. The LLM can convert the mapped tokens into a standardized form, ensuring consistent interpretation regardless of variations in phrasing or syntax. In some embodiments, the central controller 502 may request additional information from the request source. In some embodiments, the request can include producer 204 and/or consumer 206 specifications, expected output/input required, data types, and the like.

In some embodiments, the central controller 502 can maintain a mapping of the message bus 202 connections, message bus 202 capacities, and message bus 202 availabilities. The mapping can be stored in a local data storage for the central controller 502 or can be stored in the data store 208 in FIG. 2. After parsing the request, the central controller 502 may determine a proper configuration and connection with one or more message buses 202, and may update the mapping accordingly. The central controller 502 may then facilitate the connection from the producer 204 and/or consumer 206 to the message buses 202.

In some embodiments, producers 204 may be fully manageable, partially manageable, or non-manageable by the central controller 502. Manageability can be characterized by the ability of the central controller 502 to change aspects or connections of the producer 204 without the input of additional components or users. For example, a fully manageable producer 204 may be a producer that is part of the system administrators of the system have sole control of the producer 204. Partially manageable producers 204 may be producers that the central controller 502 has limited access to but can adjust in some manner. A partially manageable producer 204 may be configurable by the central controller 502 such that the central controller 502 can reroute a connection from a first message bus 202 to a second, potentially new message bus 202 without input from a producer administrator, or with limited permissions required from a producer administrator. In some embodiments, a non-manageable producer 204 may be a producer that is completely managed by an external source such as an external administrator of a vendor. In such embodiments, the central controller 502, upon detecting a fault, may provide instructions to the producer 204 to reroute a connection to a secondary message bus 202 but may not complete the rerouting. In some embodiments, rerouting connections to a secondary message bus may require the central controller 502 to generate a new deployment that can enable a connection to a non-manageable producer 204. In such embodiments, the central controller 502 may generate the deployment and provide the deployment or connections to the deployment to the producer 204 for the producer 204 to instantiate.

Similarly, consumers 206 can be fully manageable, partially manageable, or non-manageable by the central controller 502. As with producers 204, a fully managed consumer may be a consumer on the system such that the system is in complete control of the consumer 206. A partially managed consumer 206 may be a consumer 206 that the system has limited ability to configure and may or may not require permissions from an administrator of the consumer 206 to connect the consumer 206 to a secondary message bus. A non-manageable consumer 206 may be a consumer completely in the control of a secondary administrator, such as a vendor, in which any adjustments to the connections to the message bus 202 may be required to be completed by an administrator of the consumer 206.

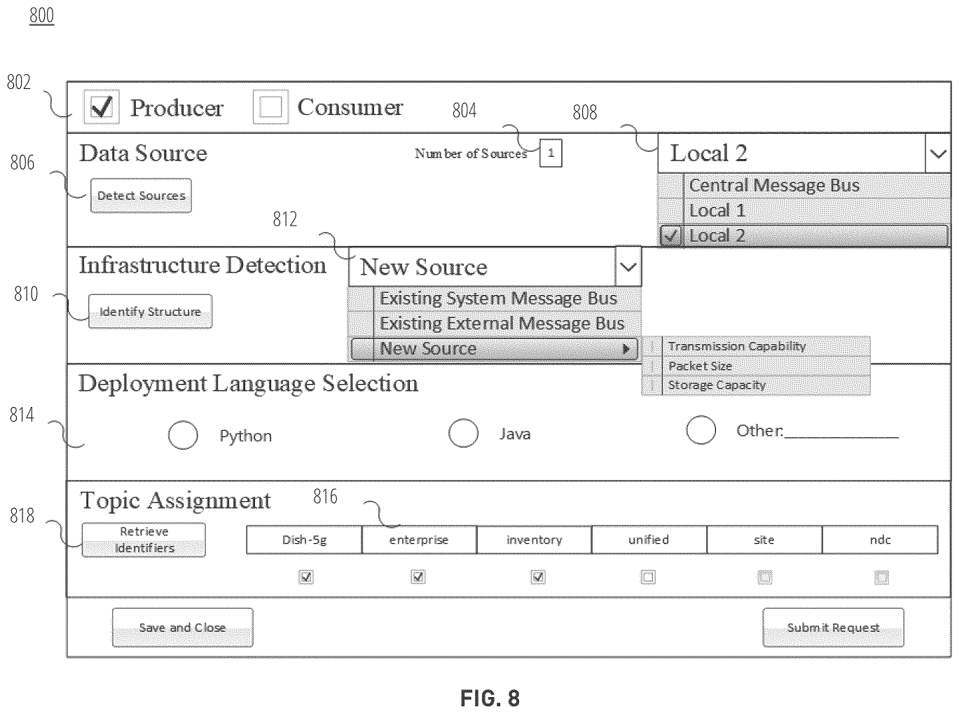

As described later in FIG. 8 to FIG. 10, removing a connection to a first message bus 202c and rerouting connections between a producer 204 and a consumer 206 to a secondary message bus 202d may require a deployment of instructions and/or message buses based on characteristics of the clients. Further description of generating deployments can be found in those figures.

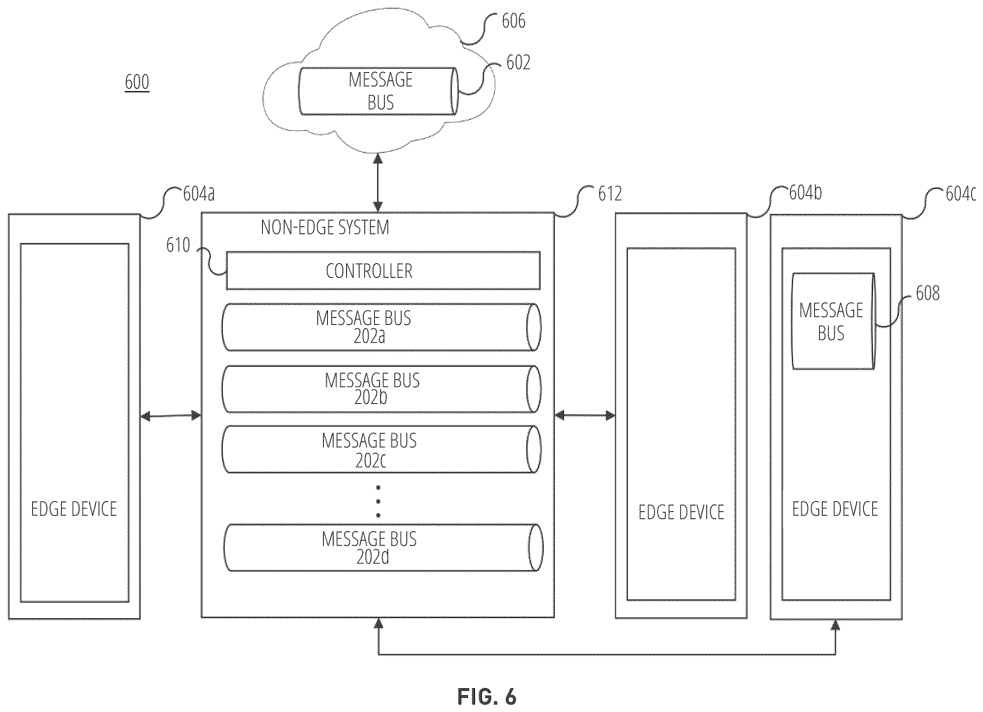

FIG. 6 shows message buses 202 within a non-edge system 612, a message bus 608 at an edge device (e.g., edge distribution center) 604, and a message bus 602 in cloud storage 606 according to at least one embodiment. As described above, the edge devices 604 can communicate with, or store, O-RAN components such as RUs 112 and DUs 114. In some embodiments, message buses 202, 602, and 508 can be deployed throughout a telecommunication system 600. The telecommunication system 600 can be a telecommunication system 600 as shown and/or described above in FIG. 1 to FIG. 5. The telecommunication system 600 can include connections for the non-edge system that exists in hierarchical layers above the edge devices as described in FIG. 3 above, that connect to multiple edge devices 604 and cloud computing environments 606. As described above, producers 204 and consumers 206 can provide or receive data within the system 600 using message buses 202, 602, and 508. The message buses 202 can be on the hierarchical layers of the non-edge system 612 within the telecommunication system 600.

In some embodiments, the edge devices 604 can be producers 204 and/or consumers 206. In some embodiments, edge devices 604 can be used to optimize network performance of a telecommunication system 600. Edge devices 604 can be positioned at an edge of the telecommunication system 600, close to end users, to help process, store, and route data without requiring communications back to the non-edge system 612, or a central system. Edge devices 604 can generate data, consume data, and store message buses 608 to supply data from producers 204 to consumers 206. The edge devices 604 can include equipment and systems to serve as a central hub for delivery and distribution of telecommunication services to end users. Edge devices 604 may include equipment such as racks, servers, power supplies, signal processors, telecom service equipment, modulators, environmental control systems, and the like. In some embodiments, the edge devices 604 can include one or more O-RAN components generating data as described in FIG. 1. The O-RAN components can be normalized by a telemetry data framework and can be provided through message buses 202 to consumers.

In some embodiments, the edge devices 604 can produce data with regards to any of the systems and equipment within the edge device 604, O-RAN components or non-O-RAN components. In some embodiments, edge devices 604 can generate network performance data, user data, device and IoT data, traffic management and routing data, security and threat data, content and application data, base station data for mobile networks, edge device health and monitoring data, and the like. In some embodiments, consumers 206 can utilize some or all of the generated data from an edge device 604 and can process the data for different uses.

In some embodiments, the data may indicate time-sensitive issues, such as network blackouts identified by performance data showing packet loss. For these cases, it is beneficial to have a message bus 608 on the edge device 604c, enabling direct and rapid data transmission from the edge device to the consumer 206, bypassing the non-edge system 612. In some embodiments, the edge device 604 can act as a consumer 206.

In some embodiments, message buses 202 may be at a non-edge system 612, such as at a central hub for one or more edge devices, and/or a message bus 608 may be deployed locally at an edge device 604c. A message bus 608 at an edge device can provide faster data communication. For example, an edge device 604c may be providing data that is used by two or more O-RAN components within the edge device 604c on two or more separate hierarchy levels and a third-party consumer. By deploying the message bus 608 directly on the edge device 604, the O-RAN components may receive the data directly without having the data pass through additional components at the non-edge system 612.

Depending on the type of data being collected and consumed, the telecommunication system 600 may benefit from the lower latency provided by a message bus 608 at an edge device 604c, or it may use a message bus 202 located in the non-edge system 612. For example, an edge device 604a may produce data that indicates high network traffic at the edge device 604. High network traffic may be an issue that needs to be addressed but may not be a time-sensitive issue. The edge device 604a and the edge device 604b may provide network traffic data to a consumer 206 through a message bus 202 at the non-edge system 612. The consumer 206 may determine that a second edge device 604, is experiencing much lower network traffic than the first edge device 604a, such that the second edge device 604b could accept additional network traffic loads. The consumer 206 can utilize the data from the first and second edge devices 604a-b to determine if the network traffic needs to be reallocated or if an additional edge device 604 is required, and where, geographically, it should be added.

In some embodiments, the third-party consumer may receive the data from the message bus 608 deployed on the edge device 604c, or the data for the third-party may be provided through a message bus 202 within the non-edge system 612. While the data may take longer to be delivered to the third-party, a central message bus 202 may be an access point that connects multiple edge devices 604 with the third-party, allowing the third-party to maintain a singular access point. In some embodiments, the system may utilize the central message buses 202 to protect the edge device 604c by abstracting the access by third parties.

The message bus 602 can be a message bus 602 stored in a cloud computing environment that is stored remotely from, and/or external to, the telecommunication system 600. In some embodiments, the cloud computing environment 606 can be owned and maintained by a third-party. By utilizing a message bus 602 on a cloud storage system 606, the consumer access point may be further abstracted from the telecommunication system 600, protecting the system from external interference. In some embodiments, cloud storage may allow for an increased message bus 602 capacity and increased accessibility across devices and locations, particularly for remote access, and the like.

In some embodiments, the message bus 602 in the cloud computing environment 606 can serve as the communication pathway between a producer 204 and a consumer 206. After this assignment, the system 600 may send requests that allow the producer and/or consumer to send or receive data via the cloud-based message bus 602. The requests may be provided by the controller 610 and may include identifying information for the producer 204 and/or the consumer 206 to enable data communication. In some embodiments, controller 610 may be the same or different from the central controller 502 in FIG. 5. Identifying information within the requests may include, but is not limited to, bus address including an IP address of the message bus, port number, authentication and authorization information, connection settings and protocol details, message bus topic, and the like. Information can be added or prevented based on the information that is required to establish the connection.

In some embodiments, the controller 610 of the non-edge system 612 is a central controller 502 as described in FIG. 5. The controller 610 be used to receive a request from the edge device 604c, and cause deployment of the message bus 608 associated with the producer on the local distribution center. In some embodiments, each time an edge device is brought online, a request for a message bus is provided to the controller 610 and a message bus 608 is configured and deployed at the edge device 604. In some embodiments, based on the hierarchy level of the edge device 604 as described in FIG. 3, the message bus 608 may be configured and provided to the edge device 604. For example, an RDC within the system may include one or more LDCs and may generate or collect more data than a single LDC; therefore, a message bus 602 for an RDC may have a higher capacity than a message bus 602 deployed at an LDC. In some embodiments, the controller 610 may include a processing unit and a memory storing one or more executable instructions that cause the controller 610 to enable communication channels between the producers 204, consumers 206, and message buses 602 and 608.

In some embodiments, the controller 610 can be configured to determine the specifications of the message bus 608 based on the request. For example, the data capacity may be determined based on an anticipated data output of the edge device 604. In some embodiments, the message bus 608 may be configured based on the anticipated data usage. For example, an LDC producing data in a geographic region that may require more monitoring, for example, a heavily populated area, may need to support more consumer 206 connections. A heavily populated area may be monitored more closely as telecommunication system 600 outages may cause more problems than in a less populated area. Therefore, additional health checks on the edge devices 604, performed by additional consumers 206, may be required.

In some embodiments, the controller 610 may monitor connections to the message bus 608. Although the data is not being routed through the non-edge system 612 and non-edge system 612 components, the controller 610 may still monitor and control producer 204 and consumer 206 connections with the message bus 608 deployed at the edge device 604. The controller 610 may enable the connections to consumers 206 and may cause connections to the message bus 608 to be rerouted to other message buses in the telecommunication system 600, such as message buses 202 and 602, upon detection of an error or fault within the message bus 608.

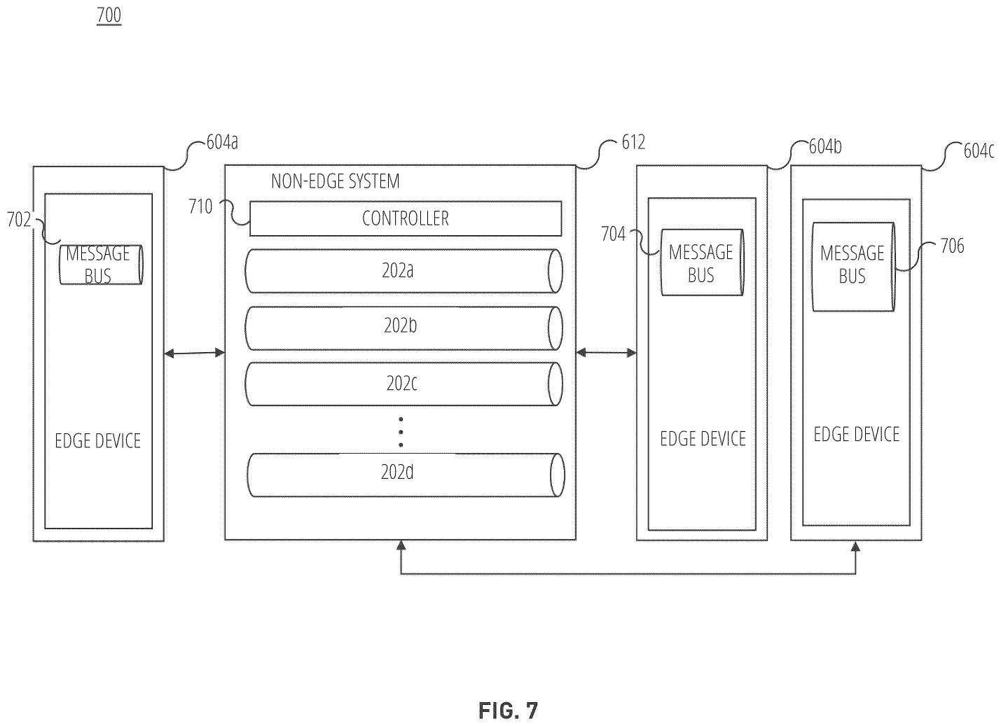

FIG. 7 shows telecommunication edge message buses 702, 602, and 608 deployed based on edge device 604 capabilities, according to at least one embodiment. As described in FIG. 6, a message bus 608 can be deployed at an edge device, such as an edge device 604 of a telecommunication system 600. In some embodiments, configuring a message bus 608 for deployment can include creating a message bus 608 in response to the request and according to specifications of the edge device 604. In some embodiments, pre-generated message bus configurations are stored within, or are accessible to, the controller 610. Pre-generated message bus configurations can be message buses of varied sizes and transmission capabilities that have varied capacity and computational requirements. For example, a message bus 702 of a first size may not have as large a message throughput capacity as a message bus 704 of a second size. However, because of the decreased throughput capacity, the message bus 702 of the first size may require fewer resources to support than the higher capacity message bus 704, thus decreasing producer resource utilization. Resources of the edge device 604 to support a message bus 702, 602, 608 may include, but are not limited to, central processing specifications, memory, bandwidth, and the like. In some embodiments, the higher the throughput capacity of the message bus, the more resources of the edge device 604 are required to support the message bus.

In some embodiments, a size of a message bus to be distributed to an edge device 604 is determined based on configuration settings included in the request, for example, size limitations of the edge device 604. In some embodiments, the request is provided during configuration of the edge device 604 and can include desired specifications of the message bus or the specifications of the deployment location. For example, in a request, an edge device 604a may indicate a desired message bus 702 capacity. The message bus 702 may be provided to the edge device 604a only on the condition that the message bus 702 satisfies the desired capacity provided as part of the request. In some embodiments, the request provided by the edge device 604a may include identifiers associated with a specific message bus 702 capacity. For example, message buses may be identified as Size A, Size B, Size C, and the like. As part of the request, the edge device 604 can indicate the desired message bus 702 by requesting “Size A”. In some embodiments, only the desired capacity, or specific message bus 702 identification, will be used by the telecommunication system 600 to determine the message bus 702 to deploy.

In some embodiments, the edge device 604a may provide a request for a message bus 702. The request may include edge device 604a information such as memory, bandwidth, and expected output. In some embodiments, the edge device information may be provided as part of the request, for example as an input to a request generated by a user. In some embodiments, the edge device information may be provided as part of the request such that it is collected by the edge device 604 to be sent with the request. In some embodiments, the edge device information can be identified automatically by the central controller 610. For example, if an edge device 604 is being connected to the telecommunication system 600, during configuration of the edge device 604, specifications for the edge device 604 may be provided to the telecommunication system 600. In requesting deployment of a message bus 702, the telecommunication system 600 may utilize the specifications of the edge device 604 collected to connect the edge device 604 to the telecommunication system 600. For example, an edge device may include devices that have a set capacity for data intake. Using the capacity, the controller 610 may identify a message bus capacity that can satisfy the data generated by the edge device 604.

In some embodiments, when generating a request for a message bus, an edge device 604 may set default edge device information based on the specifications of the edge device 604. For example, an edge device 604 may include devices that have a set capacity for data intake. Upon attempting to request a message bus 702, the request may be auto-populated to request generation of a message bus 702 that can handle all data that could potentially be generated by the edge device 604. In some embodiments, however, an edge device 604 may have a potential capacity for data intake but may not be intended to be used at capacity. As message buses 702 utilize resources of the edge device 604, it may be beneficial to request deployment of a message bus 702 that is configured to throughput an expected capacity rather than a possible capacity of the edge device 604. In such embodiments, a user and/or an automated system may update the populated fields to reflect the anticipated throughput rather than the possible throughput of data.

Using the requirements for the message bus provided by the request, the system 700, for example at the controller 610, may identify one of the pre-generated message bus configurations. For example, a first message bus 702 can have a throughput capacity 100 megabits per second (Mbps), a second message bus 704 can have a throughput capacity of 500 Mbps, and a third message bus 706 can have a throughput capacity of 1 Gbps. If the request indicates that the edge device 604a will have an expected throughput requirement of 80 Mbps, the controller 610 may determine that the first message bus 702 should be deployed to the edge device 604a.

In some embodiments, edge devices 604 may be existing components of a system 700 that require a message bus to be deployed at a time after the edge device 604 has been integrated into the system 700. In such embodiments, the controller 610 may have access to information regarding the edge devices 604 to utilize to determine a message bus 702, 602, and 608 to deploy. In some embodiments, based on a point of connection within the system 700, the controller 610 may be able to assume message bus 702, 602, or 608 characteristics. For example, an edge device 604 of a first type may be identified as being deployed in a highly populated region based on the connection point. An edge device 604 deployed in a highly populated region may be expected to output a maximum amount of data of the edge device 604. Whereas an edge device 604 of the first type being deployed in a less populated region may not be expected to run at capacity of the edge device 604. Based on the region of deployment, the controller 610 may determine that a message bus that can satisfy the throughput of an edge device 604 generating a maximum amount of data may be deployed in the edge device 604 in the highly populated region and a message bus that can satisfy a lower throughput of edge device data may be deployed in the edge device 604 in the less densely populated region.

In some embodiments, an edge device 604 may require more than one message bus to satisfy throughput requirements. In some embodiments, rather than select a preconfigured message bus of a larger size, the controller 610 may determine resource allocation would be best served using two message buses of a smaller size. For example, the first message bus 702 may require a first number of resources and the second message bus 704 may require a second number of resources more than two times greater than the first number of resources. An edge device 604a may request a message bus, wherein the message bus indicates a throughput capacity requirement of 110 Mbps. The message bus 702 with the lowest throughput capacity would not satisfy the requirements of the edge device 604a. However, two message buses of the first size of a message bus 702 would satisfy the throughput capacity requirement of the edge device 604a. The controller 610 may determine that the resources of the edge device 604a would be better served by deploying two message buses 702 of the first size instead of deploying a single message bus of the second size.

In some embodiments, selecting a message bus for deployment of a message bus 702, 602, and 608 within a system 700 can be completed using artificial intelligence and machine learning. In some embodiments, systems 700 can include tens, or even hundreds of edge devices 604. Edge devices 604 may not all the configured at the same time and may not all request message bus deployment at the same time. As additional edge devices 604 of similar types are added to the system 700, the system 700 may learn expected capacity of like edge devices 604. In such embodiments, rather than requiring a message bus request, or certain requirements as part of a message bus request, the system 700, for example at the controller 610, may utilize learned traits of edge devices 604 to determine which size of message bus 702, 602, and 608 to deploy. In some embodiments, common artificial intelligence systems can be trained using expected yields based on edge device type and can be updated during use depending on message bus requirements identified during use.

FIG. 8 illustrates an example graphical user interface 800 for data producers 204 connecting to the message buses 202 of FIG. 2 according to at least one embodiment. As described in FIG. 2 to FIG. 6, a producer 204 may provide data to one or more consumers 206 via one or more message buses. In some embodiments, upon integration with the system 200, a producer 204 may provide producer information to the system, for example at the controller 610. To properly connect producers 204 to message buses to provide data to consumers 206, the system, for example at the controller 610, can utilize producer information to determine to which message buses to connect the producer 204. Shown for example in FIG. 3, producers 204 may be configured and/or directed to supply data to one or more message buses. In some embodiments, producer information can include client characteristics of the producer such as characteristics regarding components used at the producer. For example, a characteristic of a producer could include CPU metrics, storage capacity, antenna transmission packet size, etc.

Onboarding a producer 204 to a system, for example an edge device 604, may include registering the producer 204 via a graphical user interface. The graphical user interface 800 may be accessible over an internet connection, via source code input to the producer 204, direct line communication with the system 200, or the like. The graphical user interface 800 for connecting the producer 204 to the system can first identify that the device providing the information is intended to be a producer 204 within the system 200. In some embodiments, the graphical user interface 800 can include an interaction object 802 for indicating that the provided information is for a producer 204. In some embodiments, the graphical user interface 800 will be limited to only accepting producer information and no interaction object 802 may be required for the onboarding process of the producer 204.

As described above in FIG. 1 to FIG. 3, a producer 204 may include one or more subcomponents, for example O-RAN producers, which may need to be treated individually by the system when connecting the producer 204 to the message bus. For example, each subcomponent may be directed to a different message bus or may include identifying data during transmission to indicate O-RAN producer source. The number of sources can be provided to the graphical user interface through an input interaction object 804, that allows a user to input the exact number of data sources, for example the number of O-RAN components. In some embodiments, if a user and the system do not have readily identifiable information on the number of sources utilized by the producer 204, the user can interact with a detection interaction object 806 that can identify within the producer the number of subcomponent producers that need to be accounted for.

In some embodiments, the graphical user interface 800 can be used to identify where the message bus should be deployed. As shown, a drop-down interaction object 808 could be used to identify whether a message bus residing on the central system, a first local edge device, or a second local edge device, should be used for the producer 204. As described in FIG. 4 and FIG. 5, a non-edge system may comprise one or more message buses 202. When connecting the producer 204 to the system, a user or computing device at the producer 204 may determine that the data produced by the producer 204 is best served using a message bus at the non-edge system. For example, if the data does not require and/or would not be significantly better served by decreased latency of data communication over a message bus, the user, and/or the computing system of the producer 204 may select the central message bus from the drop-down interaction object 808.

In some embodiments, a telecommunication system may include multiple levels of abstraction away from the central system such that one or more edge devices, for example edge devices 604, may depend on each other. A first local message bus may be stored on an edge device on a higher hierarchical level than the producer 204 is going to be deployed on. For example, Local 1 may be a message bus deployed on an RDC edge device, and producer 204 may be deployed on an LDC edge device which connects to the central system through the RDC. Should the user and/or the computing system of the producer 204 determine that the data produced by data producer 204 may require lower latencies than would exist being transmitted through a message bus on the central system, but would not require data transmission rates achievable by a message bus on the producer 204, Local 1 may be selected from the drop-down interaction object 808, thus connecting the producer 204 to a message bus deployed on a nearby edge device 604.

In some embodiments, as described above, data produced by a producer, for example at an LDC in a densely populated area, may require low latency data communication through a message bus to consumers 206. In such embodiments, the user and/or the computing system of the producer 204 connecting the producer 204 to the message bus may identify Local 2 or the producer 204 as the location for deployment of the message bus.

In some embodiments, the graphical user interface 800 to connect to the producer 204 to a message bus may include data about the producer 204 that can be used by the central controller 610 when determining a message bus for the producer 204. In some embodiments, the graphical user interface 800 can include and identify interaction object, depicted as a button, which can direct the system to self-identify data that may be relevant for the controller 610. In some embodiments, a producer 204 may be intended to connect to an already established message bus. For example, an RDC may be connected to two or more LDCs within a telecommunications system. A first LDC may be connected via the graphical user interface 800. During the connection of the first LDC to the system, a message bus may be deployed at the RDC and connected to the first LDC as a producer. The second LDC may subsequently be connected to the system via the graphical user interface 800. When connecting the second LDC, the user may indicate, using a source drop-down interaction object 812, to use an existing system message bus. A second interaction object may appear, in some embodiments, to allow the user to identify the desired message bus, for example the message bus on the RDC that is connected to the first LDC.

In some embodiments, the user may determine that the advantages of a message bus on a cloud computing system, for example message bus 608 in cloud 606 of FIG. 6, would be best for the producer 204. In such embodiments, the user can select the existing external message bus for connection to the producer 204. In some embodiments, a new producer 204 may be a new source for which a user does not have an identifiable message bus. Rather than automatic identification of structure using the identify structure interaction object 810, the user can interact with the source drop-down interaction object to input new source details, for example transmission capacity, packet size, storage capacity, and the like. The inclusion of the new source data can allow the controller 610 to generate and/or identify a message bus based on the required specifications of the producer 204.

In some embodiments, should a new source require a new message bus to be deployed on the producer 204, the user may use deployment language interaction objects 814. The controller 610 may have the capabilities of generating and/or deploying a message bus in a first language and a second language on a producer. In some embodiments, a producer may be configured to understand and interpret the first language and/or the second language. In some embodiments, however, the producer 204 may not be able to support deployment of a message bus in the first language or the second language, in which case the user can identify another language in which the message bus can be deployed.

In some embodiments, deployment of a message bus in a third language may require the controller to generate a message bus, or bridge to message bus code in the first language and the second language that can be deployed on the producer 204. In some embodiments, the controller 610 upon receiving indication of a third language selection, may direct the producer 204 to generate data that is normalized in such a way that it can be supported by a message bus in the first language or the second language. For example, the controller 610 may provide the producer 204 with an expected format for data that can be passed through a message bus in the first language or the second language, and can direct the user to change data output formatting from the third language to formatting that can be supplied to the message bus in the first language or the second language.

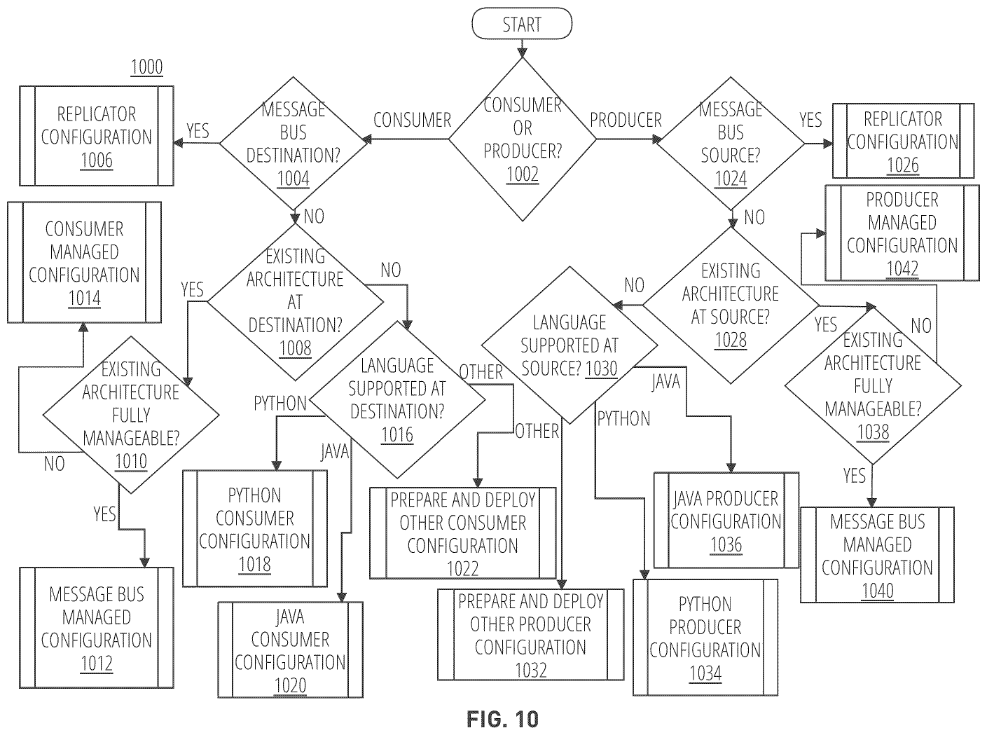

In some embodiments, the data that is supplied to, or retrieved 818 by, the message bus can be provided with identifiers 816 generated as part of the data. As described in more detail in FIG. 10, the data identifiers 816, or topics, can be retrieved for the producer 204 and listed for the user to identify which topics should be transmitted with the data and which topics can be disregarded. Topics can be used to identify data that should be collected from a producer 204 and/or provided to a consumer 206. For example, a consumer may only be interested in data associated with an inventory topic, and by including inventory as part of the topics included in data identifiers, only inventory-related data can be transferred to the consumer 206. Should the inventory topic be excluded from transmission, a message bus transmitting the data from the producer 204 to a consumer 206 will be unable to identify inventory-related data and will therefore not transmit inventory data to the consumer 206.

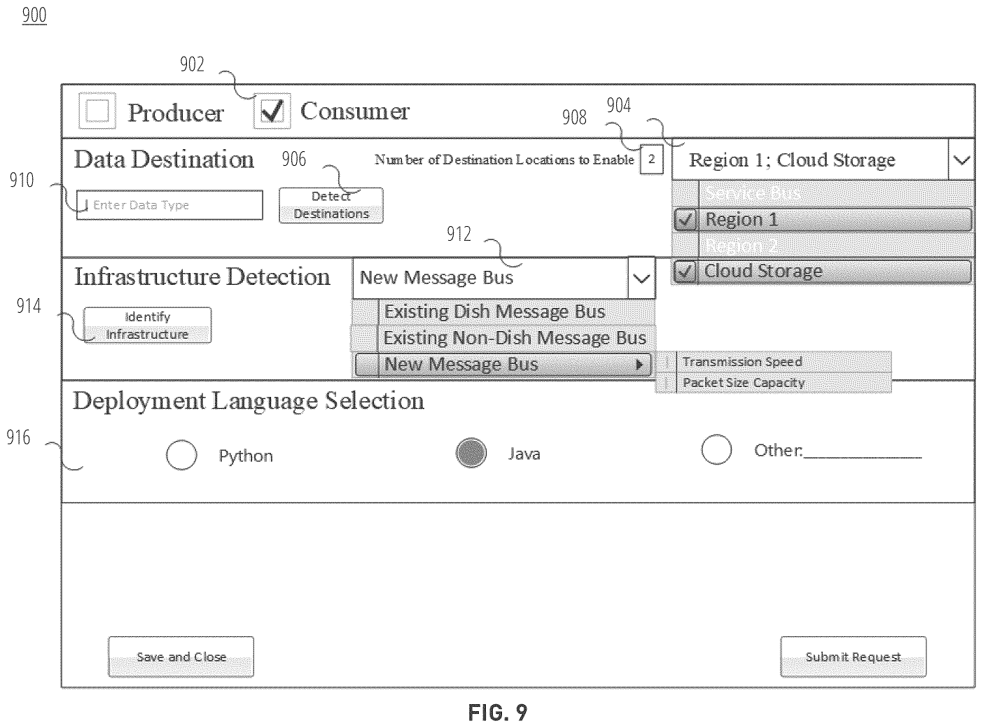

FIG. 9 illustrates an example graphical user interface for data consumers connecting to the message buses of FIG. 2 according to at least one embodiment. As described in FIG. 2 to FIG. 6, a consumer 206 may receive data from one or more producers via one or more message buses. In some embodiments, upon integration with the system 200, a consumer 206 may provide consumer information to the system, for example at the controller 610, to enable connection to the proper message buses. To properly connect consumers 206 to message buses to receive data, the system, for example at the controller 610, can utilize consumer information to determine which message buses to connect the consumer 206. As shown, for example in FIG. 4, consumers 206 may be configured and/or directed to receive data from one or more message buses. In some embodiments, consumer information can include client characteristics of the consumer, such as characteristics regarding components used at the consumer. For example, a characteristic of a consumer could include CPU metrics, storage capacity, antenna transmission packet size, etc.

Onboarding a consumer 206 to a system may include registering the consumer 206 via a graphical user interface 900. The graphical user interface 900 may be accessible over an Internet connection, via source code input by the consumer 206, direct cable communication with the system 200, or the like. The graphical user interface 900 for connecting the consumer 206 to the system can first identify that the device attempting to connect with the system is a consumer 206. In some embodiments, the graphical user interface 900 can include an interaction object 902 for indicating that the provided information is for a consumer 206. In some embodiments, the graphical user interface 900 will be limited to only accepting consumer information and no interaction object 902 may be required for the onboarding process of the consumer 206.

As described above in FIG. 1 to FIG. 4, a consumer 206 may be dedicated to evaluating data from a region and/or slice of a telecommunication system either as the data is being produced in real-time, or later at a non-real-time. Depending on the intended use of the data and the data intended to be consumed, the user may identify one or more destination locations using a drop-down destination interaction object 904. A destination location may describe an area within the system that the consumer 206 intends to operate. For example, a consumer 206 that is intending to operate on real-time data for a first region, the destination would be at region one. If consumer 206 intends to operate on real-time data for a second region, the destination would be at region two. A consumer that is not intending real-time consumption of data may indicate cloud storage as the destination. A consumer 206 that designates cloud storage as a destination may not, in some embodiments, be a consumer 206 that consumes data, and may instead act as a data store for data supplied from the producers 204. In some embodiments, a destination can be a message bus. A message bus as the destination can enable the system to deploy a replicator as a consumer 206 that replicates the data that goes through the message bus. Based on the destination, the system can determine the type of consumer 206 that will be receiving data and can identify deployment information to connect the consumer 206 with the message bus to enable the data to be properly handled according to the destination. For example, based on a cloud storage destination, the system can indicate to the message bus to provide the data to a data store in the cloud storage. Based on a message bus destination, the system can determine a need to deploy a replicator to the message bus to replicate the data going through the message bus.

In some embodiments, destinations can be detected using detection interaction object 906. Using the object 906, the consumer 206 may identify the destination in which the graphical user interface 900 is being accessed to determine a destination. For example, using the object 906 the consumer 206 might identify the graphical user interface 900 that is being accessed via a cloud storage environment by a user device that is geographically located in region one. Therefore, the detected destinations may include both Region 1 and cloud storage. The user may, upon viewing the detected destinations, adjust the destinations according to user preference.

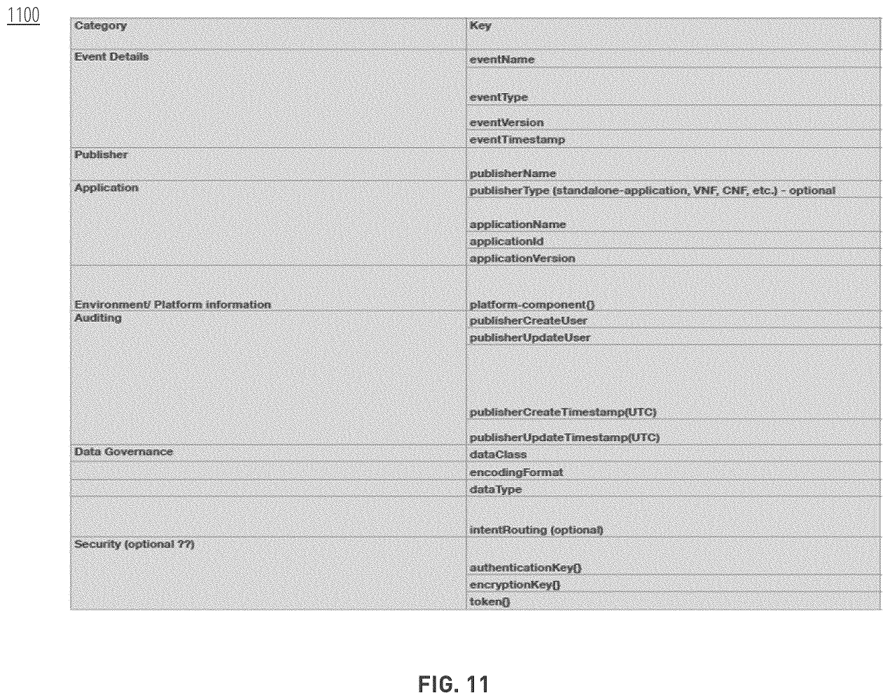

In some embodiments, data provided at a destination can be further limited by data type. As briefly described in FIG. 8 and more thoroughly described in FIG. 11, data generated by a producer 204 can be identified by one or more data types depending on the data generated. The consumer 206 can be limited to receiving data that the consumer 206 will utilize by input from a user at input interaction object 910. When generating a consumer 206 that has one or more destinations, data types received by the consumer 206 can be segmented such that a first destination can receive a first set of data types and a second destination can receive a second set of data types. For example, a consumer 206 that specifies a destination of Region 1 and a destination of cloud storage may indicate data types to receive at region one that need real-time data analysis for real-time data consumption. Consumer 206 may designate one or more data types that do not require real-time data analysis to be received at the cloud storage destination of the consumer 206. In some embodiments, the consumer 206 can utilize the cloud storage destination data provided to the cloud storage. For example, if the consumer 206 has finished processing the data received at Region 1, the consumer 206 may utilize the time to consume the data in cloud storage.

In some embodiments, a consumer 206 may be previously integrated into the system such that it is connected with one or more message buses. In such embodiments, the system, for example at the controller 610, may have stored an existing example connection point for the consumer 206 to the system. The existing example connection point may be used as a model to generate a new connection point. In some embodiments, the system can supply the additional data requested by the request in the graphical user interface 900 through the existing message bus. In some embodiments, the existing message bus may be a bus external to the system, for example a cloud storage message bus, which the system can direct the additional data through. In some embodiments, a connection point to a new message bus may be required for the consumer 206 to complete the request in the graphical user interface 900. In such embodiments, the system, for example at the controller 610, may require an understanding of the infrastructure of the consumer 206 to create a connection point with the message bus. Depending on the type of bus required for the consumer 206, the user can identify the bus in the message bus dropped down interaction object 912. In some embodiments, the graphical user interface 900 can be utilized by the user to begin an infrastructure identification using interaction object 814. In such embodiments, the consumer 206 may be queried to identify message bus connections and message bus capacity infrastructure of the consumer 206. Rather than automatic identification of structure using the identify structure interaction object 914, the user can interact with the bus drop-down interaction object 912 to input new bus details, for example transmission speed, packet size capacity, and the like. The inclusion of the new bus data can allow the controller 610 to generate and/or identify a message bus connections based on the required specifications of the consumer 206.

In some embodiments, should a new source require a new message bus to be deployed to enable the connection, or a message bus connection point be deployed, the user may use deployment language selectors 916. The controller 610 may have the capabilities of generating and/or deploying a message bus in a first language and a second language or enabling connection via the first language or the second language. In some embodiments, a consumer may be configured to understand and interpret the first language and/or the second language. In some embodiments, however, the consumer 206 may not be able to support deployment of a message bus in the first language or the second language, in which case the user can identify another language in which the message bus can be deployed.

In some embodiments, deployment of a message bus in a third language may require the controller to generate a message bus, or bridge to message bus code in the first language and the second language that can be deployed on the consumer 206. In some embodiments, the controller 610 upon receiving indication of a third language selection, may provide the consumer 206 with a translation map to normalize data received from the message bus into a usable format.

FIG. 10 is flow diagram 1000 of a method for smart producer message bus configuration and consumer message bus configuration, which may be configurations of message bus connection architecture according to at least one embodiment. In the smart producer and consumer configuration, a data producer 204 or data consumer 206 can be used to automatically or manually make a request to utilize the message bus communication logic 102 of the system 103. Automatic requests can be made when a producer 204 or a consumer 206 is first connected into the system 103. Manual requests can be made by a user at a producer 204 or a consumer 206, for example by utilizing the graphical user interfaces 800 and 900 of FIGS. 8 and 9. To generate message buses 202 and/or message bus connections to a producer 204 or a consumer 206, the system, for example at the controller 502, may use a smart configuration process. The process may start by determining whether the device attempting to connect to the system is a consumer or a producer. If the connection request is made by a consumer 206, the controller 502 may determine if the message bus is the destination 1004 of the data that is being requested by the consumer 206. A message bus 202 can be identified as a destination by a consumer 206 that may not need the data immediately, but may, at a later time, access the data.

If the message bus is the destination of the data, the controller 502 may determine a need to deploy a replicator configuration 1006 to replicate the data for storage at a location that is not the consumer 206. A replicator configuration can exist in combination with the message bus to replicate the data that is being passed through the message bus to the consumer 206. Rather than passing data directly to a consumer, the data is simply replicated and may be provided in a secondary location for storage. In some embodiments, replicating the data via a replicator configuration used in tandem with the message bus can be initialized for the purpose of fault tolerance. For example, if the data is important to overall system health and/or may be necessary for data interpretation at a later time, the data can be replicated to be preserved in case of a fault. The replicator can allow for the data to be stored in a separate location from either a consumer 206, the producer 204, and any data store for data that is being produced by a producer 204 that is being maintained for future use and is not being supplied to a consumer 206. In some embodiments, the replicator configuration 1006 can be implemented for the purpose of scalability such that multiple consumers can connect to the replicas, reducing the load on any single instance of data. In some embodiments, the replicator configuration 1006 can be implemented for data consistency to aid in strong data consistency through a distributed system enabling replication throughout the system to ensure widespread data storage.

If the message bus is not the destination 1004, the controller 502 may identify whether an existing message bus architecture exists at the destination 1008. Existing message bus architecture can include, for example, a message bus connection point that was previously established to a message bus housed on the system. A message bus housed on the system, for example, can be a message bus 202 on the non-edge system or can be a message bus on an edge device 604. In some embodiments, a previous connection point can establish a connection to a message bus that is maintained by the system but stored on the cloud computing environment.

If there is existing message bus architecture at the destination 908, the controller 502 can determine whether there is an existing message bus architecture that is fully manageable 1010 by the message bus. Fully manageable architectures can include a message bus connection that is fully manageable and thereby reconfigurable by the system. Non-fully managed message bus configurations can be either entirely externally managed or partially externally managed such that the controller 502 only has partial or no control over the message bus configuration. In some embodiments, an externally managed message bus configuration can be managed, for example at a cloud computing system wherein the cloud computing system may possess some or all management over the message bus configuration and may limit system control over the cloud system message bus configuration. In some embodiments, a message bus configuration may be housed on a consumer 206 external such that the device on which the message bus configuration resides may have full or partial control of the message bus configuration.

For example, consumer 206 can be a device within the system that is controlled by the system. As part of the system, the consumer 206 will include message bus architecture that is fully manageable by the controller 610. Alternatively, a consumer 206 connected via a cloud storage system may grant limited permissions for the controller 502 to adjust the message bus architecture and connections connected via the cloud storage system. In some embodiments, a consumer 206 may be completely external to the system such that any configurations are provided as requests to the consumer 206 that are implemented at the discretion of the consumer 206 and not at the direction of the controller 502.

If the existing message bus architecture is fully manageable 1010, the controller 502 can cause deployment of a message bus managed configuration 1012 on the consumer 206 to enable new, or alter existing, message bus connections between the consumer 206 and the message bus. In some embodiments, based on the new request provided by the consumer 206, the service may identify a need to connect the consumer 206 to a message bus that is being provided alternative data from one or more producers 204. In a situation in which the existing message bus connection is fully managed by the message bus, the controller 502 can adjust the connection independent of external allowances to make the connection between the message bus and the consumer 206.

If the existing message bus architecture is not fully manageable 1010, the controller 502 can deploy a consumer managed configuration 1014. If a system does not have the ability to fully manage the message bus architecture on the consumer 206, the consumer 206 will be required to execute steps in order to deploy the proper message bus configurations to complete the request.

Returning to logic decision to determine if the existing architecture is at the destination 1008, if the destination does not include existing message bus architecture, the controller 502 can identify a language supported at the destination 1016. As described above, a destination may include a region, a consumer device identifier, a cloud computing environment, and the like. In some instances, a destination may be configured to understand and utilize a specific coding language. If the destination utilizes a Python coding language, the controller 502 will deploy a Python consumer configuration 1018 to connect the destination to a message bus for a first time. If the destination utilizes a Java coding language, the system can deploy a Java consumer configuration 1020 at the destination to connect the consumer 206 to a message bus for a first time.

Although the logic flow 1000 only depicts the system identifying Python and Java, it should be appreciated that the system may be configured to identify additional coding languages and have a ready-made consumer configuration for each identifiable coding language. In some embodiments, a destination may be identified as being in a language that is not correlated with a pre-existing consumer configuration. In such embodiments, the controller 502 may be enabled to prepare and deploy another consumer configuration 1022 based on the identified coding language. Preparing and deploying another consumer configuration may include, for example, creating a deployment configuration in the understandable language, creating a bridge between pre-existing deployable configurations and the coding language identified in the consumer 206, creating a mapping for the consumer 206 for the consumer to interpret the deployment configuration and translate the code into identifiable code for the consumer 206, and the like.

Returning to logic decision 1002, if the device attempting to connect with the system is a producer, the controller 502 can determine whether the message bus is the source 1024. As described above with the consumer 206, if the message bus is determined to be the source of the data, the controller 502 can deploy a replicator configuration 1026 such that any data that is passed into the message bus is replicated. Upon determining that the message bus is not the source 1024, the controller 502 can determine whether there is existing message bus architecture at the source 1028.

Existing message bus architecture at the source can include a message bus at the source, a message bus connector at the source, and the like. A message bus at the source as described above can include, for example, a message bus deployed at an edge device 604. A message bus connector at the source can include, for example, connection configuration for connecting the producer such as an edge device 604 to a message bus 202 stored at a non-edge system. Existing message bus architecture can indicate that the source has previously been integrated into the system such that it is supplying data to one or more message buses. If there is existing message bus architecture at the source 1028, the controller 502 can identify whether the existing message bus architecture is fully manageable by the existing architecture fully manageable 1038.

In some embodiments, the producer 204 may be connected to a message bus that is not fully managed by the system. Without full manageability of the message bus, the system, for example at the controller 502, may be unable to autonomously configure or reconfigure an update to the connection or the message bus. For example, a message bus stored on the cloud computing system may be partially or fully managed by the cloud computing system. In such embodiments, the system may not be able to adjust the connection between the cloud computing system at the message bus and the source within the system. In some embodiments, the producer 204 may not be managed by the system, and may instead be a device that is configured to provide data to the system for system use. A producer 204 could reside externally to the system could be, for example, temperature sensors and weather sensors configured to identify temperature and weather patterns near edge devices of the system. By utilizing temperature and weather pattern data from the external producer 204, the system may better interpret and categorize the data produced at system edge devices. If a producer 204 that is externally managed is attempting to connect to, or reconfigure, a connection with a message bus, the message bus architecture may be fully managed by the producer 204 that is external to the system.

If there is fully manageable existing message bus architecture within the producer 204, deploy a message bus managed configuration 1040. The message bus managed configuration may be a new configuration to connect the source to a new message bus, may be a reconfiguration message to alter existing connections between the producer 204 and the message bus, and the like. If the existing message bus architecture is not manageable by the message bus, the system may deploy a producer managed configuration 1042. The producer managed configuration may include, for example, a request to a message bus manager to adjust the connection between the producer 204 and the message bus. In some embodiments, the request may include a request to initialize an attachment between the producer 204 and a message bus managed external to the system. In some embodiments, the producer managed configuration 1042 may be requests and/or a request to the producer 204 that is managed externally to the system that will allow the producer to enable a connection with a system message bus.

If there is no existing message bus architecture at the source 1028, the system may identify a language supported at the source 1030. As described above, the system may be configured to generate and manage connections to message buses in a limited number of coding languages. For those coding languages, the system may maintain deployment configurations for those languages. If the language supported at the source is Java, the system may deploy a Java producer configuration 1036 at the producer 204. If the language supported by the source is Python, the system may deploy a Python producer configuration 1034 at the producer 204. If the language supported at the source is not a language that is standardly supported by the system, the system may prepare and deploy another producer configuration 1032. It should be appreciated that the system may support Java, Python, and/or other coding languages, but may not be limited to those coding languages. When preparing and deploying another producer configuration 1032, the system may generate a message bus in the identified coding language, may generate a key for mapping the preconfigured deployments into the identified coding language, may generate a bridge to normalize the data from the identified language to connect to a pre-existing producer configuration.

FIG. 11 shows an illustrative topic governance logic 1100 for next generation data configuration according to at least one embodiment. The system, as described above, can include O-RAN components managed by multiple vendors. Due to the disaggregation of network functions and the use of multiple interoperable components from different vendors, data may be provided to message buses using topic governance logic (e.g., identifiers) that may enable the data to be transmitted to proper consumers. O-RAN components may be producing large volumes of data with vendor-specific formatting and naming.

In some embodiments, at the telemetry data framework of FIG. 1, controllers, and/or message buses, a standardized topic governance for the various components can enable efficient and real-time data transmission of the mass amounts of data produced by the disaggregated components. At the producers, for example at O-RAN components managed by one or more vendors, the data is generated and attached to metadata and/or unique identifiers that are published to a topic within a system. Within a disaggregated telecommunication system, metadata and unique identifiers may include data type, vendor identifier, event details, publisher, application, environment/platform information, auditing, data governance, security, log topics, data stream topics, broadcast topics, topics for notifications, transactional topics, and state topics.

In some embodiments, a large language model (LLM) can parse a string of metadata and/or identifiers provided with data from a vendor. The LLM can first tokenize the input text into smaller units (tokens) to understand its structure. It can then apply deep learning algorithms to map the tokens to their semantic meaning, recognizing intent, entities, and relationships. The LLM can convert the mapped tokens into a standardized form, ensuring consistent interpretation regardless of variations in phrasing or syntax.

In some embodiments, generating a map between vendor metadata and identifiers and the standardized form for the system can occur upon configuration of a producer. As discussed above, a producer can be onboarded into the system and can request connections to message buses. When connecting to message buses, the system can identify metadata and identifiers that can potentially be generated by the producers and can use the LLM to generate a mapping between the vendor structure and the system structure. In some embodiments, the mapping can occur at the message bus, at a controller, or at a telemetry data framework through which all data will be routed prior to transmission through a message bus.

In some embodiments, a map between vendor metadata and identifiers and the standardized form for the system can occur upon deployment of a configuration. During initial onboarding, a producer may provide some or all of the possible metadata and identifiers for the vendor. In some embodiments, the producer may provide only metadata and identifiers intended to connect with the message bus identified by the initial request. Upon a desire at a later time to provide additional data that may be associated with different metadata and identifiers, a mapping or an amendment to an existing map may occur.

In some embodiments, vendor metadata and identifiers may be mapped to a preferred topic governance topology. The context of the payload, as shown in the table of FIG. 11, can include categories of data (e.g., data types) that are identifiable within the metadata and data identifiers that can be used to normalize the data using standard naming conventions. The categories can include event details, publisher details, application details, environmental information, auditing information, data governance information, and/or security information. Each category of data can be broken down into multiple subcategories that further provide information on the data being provided.

For example, within the event details category, an identifier may identify a piece of data as an event name. An event name may still be associated with the data type of event data but is specific to a name of an event. Additional event subcategories may include type, version, and timestamp. The category of publisher may include a publisher name subcategory. The publisher's name may include the application that is publishing the data. This publisher can include a vendor name and can be used to generate the mapping. For example, if a mapping exists within the system for a vendor associated with the publisher's name, the system can utilize the previous mapping rather than generating a new mapping.

In some embodiments, an application detail category can include publisher type, application name, application ID, and application version. The publisher type may indicate a type of application that is published in the data, the application name may identify the name of the application publishing the data, the application ID may identify the application publishing the data, and the application version may identify the version of the application that is generating the data. The environmental information category may include a subcategory that defines a platform component. Platform component may include data that describes the dynamic assignment between a pod and an application. The auditing category may include subcategories that include publisher create user, publisher update user, publisher create timestamp, publisher update timestamp, and the like. Subcategories within the auditing category may be used to identify users of the publisher and times in which the records created by the users were generated. The data governance category may include data class, encoding format, data type, and Internet routing. The data governance category can include data that is generated based on data transmission. The security category may include subcategories that define authentication keys, encryption keys, tokens, and the like.

When creating a mapping or when providing data through a message bus from a producer, the system may include metadata and identifier strings that have been normalized by the system. The context of the payload identified using the categories can be used to create names that can be programmatically manageable and usable for the system. Names can be descriptors used in a data string that is provided to identify data to the message bus for the message bus to transmit. For example, the samples listed in Table 1 are example names.

TABLE 1

| Component | Description | Sample |
|---|---|---|
| Organization | Entity to which the data belongs | Dish-5g |
| Wireless | Domains defined for the organization's network | Enterprise |
| Domain | | |
| Functional | Operational function in the wireless domain | inventory |
| area | | |
| Capability | The sub-function | unified |
| Data Type | Logs, notifications | |
| Network | Where in the system the data originated in the | NDC |
| Topology | context of the system | |
| Data state | Stage of data type | raw |

Viewing the components shown in Table 1, the consumers may require data that indicates network topology to determine the health of, for example, an NDC specifically. Thus, the network topology may be provided as part of the data string to the consumer. In some embodiments, the string will be expected to be in an order that includes all components without skipping a component. For example, the system may be unable to provide a data string that only includes data type without including the preceding components. In some embodiments, place fillers for the previous components can be input into the data string such that only the data type information is usable that is provided.

In some embodiments, the data string may include limitations that are utilized when generating the names for components within the data string. For example, if a first wireless domain utilizes the name “enterprise,” no other wireless domains may be input into the naming system that will be used to generate a data string with the same name. In some embodiments, a name is limited to 250 characters per topic and may include limitations on characters that can be included in the name. For example, the organization may be named “dish-5g” with a dash but may not be named “dish_5g”.

When mapping metadata and identifiers from the producer, the system may generate additional names based on the information found in the context of the payload. For example, the system may use a publisher name or a variation of a publisher name to generate an organization name that will be used in the data string. In some embodiments, the system may require generation of all types of data upon a request by a producer to join the system. An administrator or user of the producer may be required to generate names according to the naming standards for the data string prior to the producer being connected to the system. In some embodiments, the administrator or the user of the producer attempting to connect to the system may generate proposed names according to naming standards and may submit them for approval at the system. Approval can occur automatically by an internal check completed by, for example, the controller or can be completed by an administrator of the system. Only once the names have been approved, can the producer be configured as part of the system and a message bus or message bus connections be deployed.

In some embodiments, not all metadata and identifiers and their accompanying data are usable and/or will be utilized by a producer within the system. Specifically, data may be data over a sizable portion of the system or may be data generated for a small portion of the system. Data that is specialized for a small portion of the system may not be useful for data consumption in determining overall health of the system and edge devices. By eliminating the passage of data that indicates the specialized data for the small portion of the system, the system can ensure the message buses are utilized efficiently and consumers are not flooded with unusable data. As shown in FIG. 8, the truncation of topics and data associated with topics provided to a consumer or a message bus may be performed by a user via a graphical user interface 800 selecting topics to be provided with their accompanying data. For example, the data retrieved and/or input into the graphical user interface 800 includes six data topic categories. After selecting the components that will be transmitted, the system may generate a data string that includes the data in the order according to the order defined by the table.

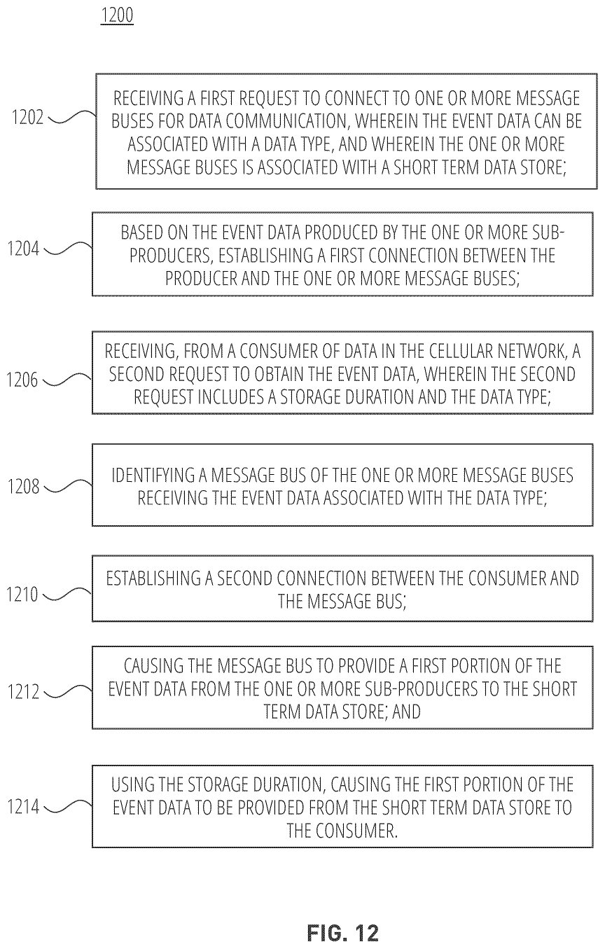

FIG. 12 is a flow diagram 1200 of a method for providing real-time and non-real-time service communication channels according to at least one embodiment. In some embodiments, the system described, for example the system 103 in FIG. 1, may be a next generation cellular network that can be utilized to connect one or more producers 204 with one or more consumers 206 for real-time data transmission and consumption. In some embodiments, data can be transmitted via one or more message buses 202 (e.g., distributed communication modules). The message buses can, in some embodiments, include a short-term data store and a memory, wherein the message bus is configured to receive next generation transmissions of event data from a client with a plurality of sub-producers. The one or more message buses 202 can, in some embodiments, receive and interpret requests to connect a producer 204 and/or a consumer 206 (e.g., a client) to the message bus 202 to facilitate the data transmission. In some embodiments, the one or more message buses 202 can connect one or more producers 204 to a long-term data store, such as data store 208. The message buses can be in data communication with a controller of the next generation network.

The method may begin with the system 200 receiving, from a producer 204 of data in a cellular network 108, a first request to connect to one or more message buses 202 for data communication, the producer 204 comprising one or more sub-producers 210 generating event data associated with the cellular network 108, wherein the event data can be associated with a data type, and wherein the one or more message buses 202 is associated with a short-term data store 214.

In some embodiments, the request includes a storage duration for the event data and a data type of the event data to be provided to the client providing the request. The communication including the request may be received at a communication interface of the system 200 that can receive messages from a producer 204, a consumer 206, and/or other user device. In some embodiments, the request can be generated by a user and/or automatically generated based on producer 204 and/or consumer 206 data throughput requirements. For example, based on a consumer interaction with the system at the consumer interface, for example as shown in FIG. 9, a user may be enabled to identify a data type desired for consumption. Additionally, the request may include identification of one or more storage durations for a portion or for all of the data types. A storage duration can indicate to a message bus 202 whether the data associated with the data type should be passed directly through the message bus 202 to a consumer 206 or whether the data associated with the data type should be passed through the message bus 202 to a long-term storage device such as data store 208.

For example, a request may identify a first data type and a second data type. The first data type may be requested to store for a short storage duration and the second data type may be requested to be stored for a long storage duration. Based on the data type, a first portion of the event data associated with the first data type may be stored in the short-term data storage of the message bus and a second portion of the event data associated with the second data type may be stored in the long-term data storage by the message bus. The second portion may be provided to a consumer based on an indication from the consumer that the consumer is ready for the data, automatic transmission based on consumer business, and the like.

In some embodiments, the request may be a request submitted by a user to reconfigure and/or determine storage duration of data types during system operation. In some embodiments, a request may be automatically generated upon initialization of a system 200 based upon preset storage durations based on data types. For example, a data type can be time dependent, such that a low latency is beneficial. The data type may then include a storage duration that indicates the data should be passed directly to any consumers 206 that request to receive data of that data type. For example, data type may not be time dependent, such that a low latency is not beneficial. In such embodiments, an initialization of the system 200 may include a preset storage duration for the data type that indicates that the data associated with the data type should be provided from the message buses 202 to a long-term data store. In some embodiments, a message bus 202 may be associated with a short-term data store 214, and a system 200 may include a long-term memory such as a data store 208. In some embodiments, the request when received at the message bus (e.g., the message bus 202) may be utilized to set up rules for it the message bus 202 to control the flow of data based on the data type and the storage duration.

The method continues at block 1204, wherein, based on the event data produced by the one or more sub-producers 210, the system 200, for example at the message bus communication logic 102 of FIG. 1, can establish a first connection between the producer and the one or more message buses 202.

The method continues at block 1206, wherein the system 200 may receive a second request from a consumer of data in the cellular network to obtain the event data. In some embodiments, the request may include a storage duration and a data type. The storage duration may indicate a length of time between event data creation and delivery of the event data to the consumer. In some embodiments, the storage duration can be used to determine if the event data associated with the data type that is to be provided to the consumer from the message bus is to be stored in a short-term data store associated with the message bus, a long-term data store, or not stored at all.

The method continues at block 1208 where the system 200, for example at the message bus communication logic 102 of FIG. 1, can identify a message bus of the one or more message buses that is receiving event data associated with the data type. In some embodiments, the data type may include identification of one or more data producers, indication of a parameter of the data such as temperature, speed, etc., indication of a device creating the data, and the like. For example, the data type may be temperature data of all servers in a geographical region. The system 200 may identify any message bus that is receiving temperature data of the servers.

The method continues at block 1210, wherein, based on the data type produced by the one or more sub-producers 210, the system 200, for example at the message bus communication logic 102 of FIG. 1, can establish a second connection between the consumer and the one or more message buses 202.

The method continues at block 1212, wherein the system 200, for example at the message bus communication logic 102 of FIG. 1 and/or using the controller, for example controller 610, may cause the message bus to provide a first portion of the event data from the one or more sub-producers 210 to the short-term data store. In some embodiments, the one or more sub-producers 210 may produce event data associated with multiple data types. Based on the storage duration received as part of the request, the event data associated with the data type may be provided to a short-term data store.

The method ends at block 1214, wherein the first portion of the event data is provided from the short-term data store to the consumer 206 for consumption, for example at the message bus communication logic 102 of FIG. 1 and/or using the controller, for example controller 610.

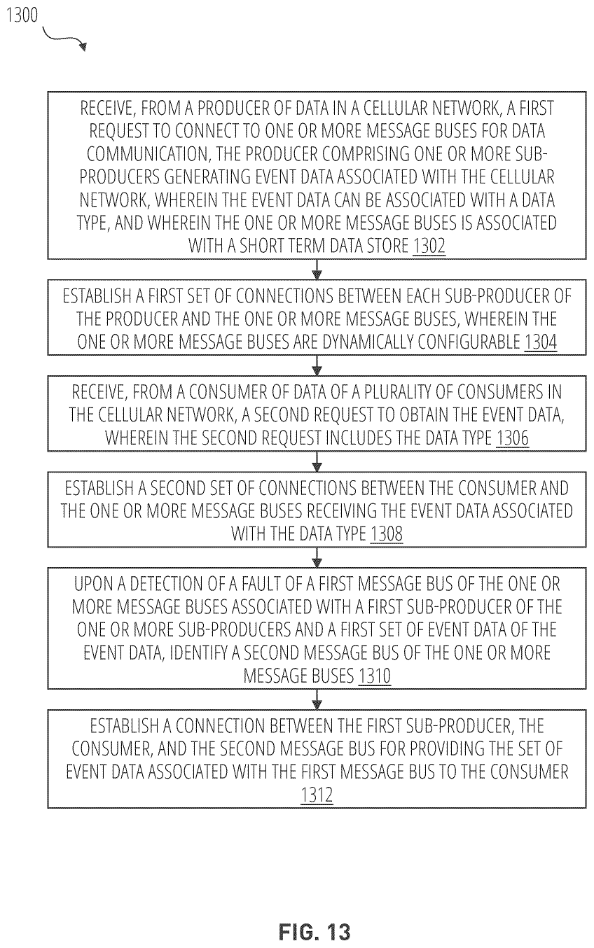

FIG. 13 is a flow diagram 1300 of a method for intelligent communication channel generation for next generation data transmission according to at least one embodiment. As described above in at least FIG. 5, a system can include a first message bus and a second message bus that each contain a storage and a memory. The first and second message buses can be dynamically configurable such that they can be managed by a controller, such as central controller 502. The method begins at block 1302 wherein the controller can receive, from a producer of data in a cellular network, a first request to connect to one or more message buses for data communication. In some embodiments, the producer can comprise one or more sub-producers generating event data associated with the cellular network. In some embodiments, the event data can be associated with a data type, and the one or more message buses can be associated with a short-term data store. The first producer, as described above, can be a producer 204 or a sub-producer 210. The request received at the controller can be one or more configuration requests as described in at least FIG. 7 and FIG. 9. The request can be a request to initialize a producer as part of the system and connect the producer to a message bus. In some embodiments, the request can include details on the producer or any of the one or more sub-producers to enable message bus assignment and/or deployment that can properly handle the data throughput required by the first producer, such as at one or more sub-producers.

The method continues at block 1304, wherein the system can establish a first set of connections between each sub-producer of the producer and the one or more message buses, wherein the one or more message buses are dynamically configurable. In some embodiments, the connection is established when a message bus, such as message bus 608, is deployed at a producer, for example at an edge device 604. In some embodiments, the connection can include a connection enabled by the producer that is managed by the system. In such embodiments, the system may configure a connection point at the producer for communication with a message bus. In some embodiments, a producer and/or each sub-producer of a producer can be partially or not manageable by the system, wherein the connection may be a deployment of a partially or non-manageable set of requests to enable the first sub-producer to connect with the message bus at the direction of a controller.

The method continues at block 1306, wherein the system can receive, from a consumer of data of a plurality of consumers in the cellular network, a second request to obtain the event data, wherein the second request includes the data type. As described above in at least FIG. 8 to FIG. 9, the consumer can be connected to the system through a graphical user interface or other methods by providing the details of the data and the consumer. In some embodiments, the consumer can request data and can define a storage duration for specific data types. In some embodiments, the consumer can request data from a specific producer and/or sub-producer.

At block 1308, based on the request to connect the first consumer of data to receive data from the first producer, the controller at block 1308 can connect the first consumer to the first message bus. As described above, connecting the consumer to the message bus may include, for example, deploying a fully manageable, partially manageable, and/or not manageable configuration to connect the consumer to the message bus based on the permissions of the controller to manage deployed configurations on the consumer.

After connection is established, in some embodiments, at block 1310 upon a detection of a fault of a first message bus of the one or more message buses associated with a first sub-producer of the one or more sub-producers and a first set of event data of the event data, identify a second message bus of the one or more message buses. In some embodiments, a fault can include a disruption in the data transmission from the first producer or first sub-producer through the message bus to the consumer. In some embodiments, the second message bus can be selected based on a utilized capacity of the second message bus known by the controller. In some embodiments, the controller can identify the second message bus as a message bus that has an existing connection to either the first consumer and/or the first producer or sub-producer such that additional configuration deployments are not required upon the connection to the second message bus.

In some embodiments, to connect the first producer and the first consumer to the second message bus, new configuration deployments may be required at the first producer and the first consumer to establish the connection to the second message bus. In some embodiments, the controller may maintain a map of connections between the plurality of producers, the message bus, and the plurality of consumers. In some embodiments, after connecting the first producer and the first consumer to the second message bus, the controller may update the map of connections. In some embodiments, upon detection of a fault, the controller may identify connections that may be appropriate for the first producer and the first consumer to resume data communication. An appropriate message bus may be a message bus that can handle the data throughput required by the connection. In some embodiments, multiple message buses may be identified by the controller as being appropriate for connecting the first producer and the first consumer. In some embodiments, the controller can be configured to analyze existing connections, potential data throughput from other producers and consumers, potential data throughput between the first producer and the first consumer, and the like to determine which of the appropriate message buses should be used.

The method continues at block 1312, wherein the system can establish a connection between the first sub-producer, the consumer, and the second message bus for providing the set of event data associated with the first message bus to the consumer.

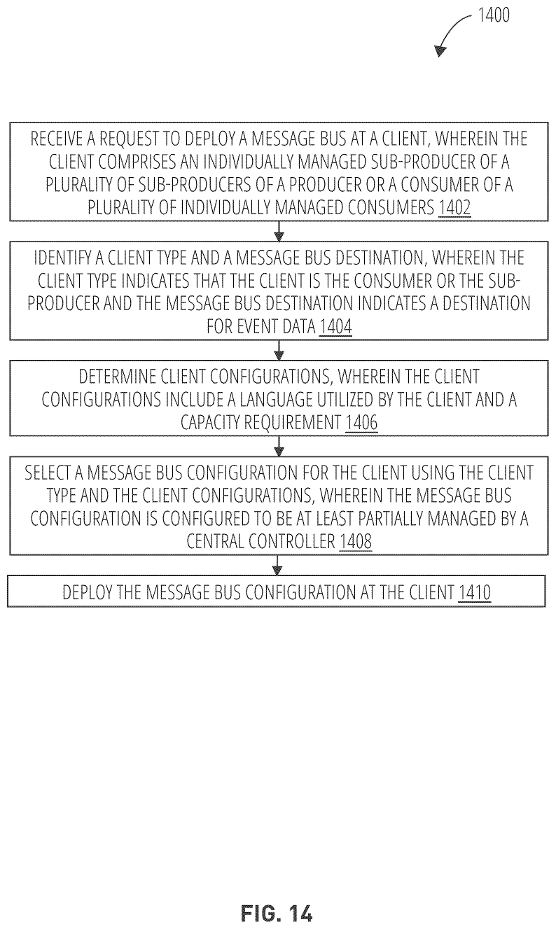

FIG. 14 is a flow diagram 1400 of a method for connecting clients to a message bus according to at least one embodiment. In some embodiments, clients can include a producer 204 and/or a consumer 206. Beginning with block 1402, the system can receive a request to deploy a message bus at a client, wherein the client comprises an individually managed sub-producer of a plurality of sub-producers of a producer or a consumer of a plurality of individually managed consumers. As described above, a request to deploy a message bus may be a request to deploy a message bus 608 at an edge device 604 as shown in at least FIG. 6 and FIG. 7 or may be a request to deploy a configuration to enable data communication between a client and a message bus as described in at least FIG. 10.

The system identifies a client type and a message bus destination, wherein the client type indicates that the client is the consumer or the sub-producer and the message bus destination indicates a destination for event data at block 1404. In some embodiments, the client type can indicate whether the client is a producer and/or a sub-producer or a consumer. In some embodiments, a message bus data destination may include defining whether the destination is the message bus, a fully manageable client, a partially manageable client, a non-manageable client, a cloud computing system, and the like. The message bus data destination can indicate where the message bus and/or the configuration for enabling message bus communications will be deployed. In some embodiments, the message bus configuration is a replicator based on the destination designating the message bus.

The method may continue at block 1406, wherein the system may determine client configurations, wherein the client configurations include a language utilized by the client and a capacity requirement. A client configuration can be included in deployment requests and can include, for example, a language for deployment, a message bus configuration, and the like. In some embodiments, determining client configurations can include identifying client information. In some embodiments, rather than reading a request to obtain all information required for generating a configuration, client configurations can be identified based on client characteristics. Client characteristics can be, for example, model types of client hardware, central processing specifications, memory, bandwidth, client position within a system, and other characteristics that can be determined based on automatic inspection of the client requesting to be integrated into the system. Central processing specifications can be technical details of hardware specifications of the client devices.

The method may continue at block 1408, where the system may select a message bus configuration for the client using the client type and the client configurations, wherein the message bus configuration is configured to be at least partially managed by a central controller. In some embodiments, generating the message bus configuration can include generating a message bus with the specifications that will satisfy the request. In some embodiments, generating a message bus configuration may include generating connection enabling requests that can be provided to the client and utilized by the client to connect the client to the message bus. In some embodiments, the generated configuration can include generating the configuration based on a coding language identifiable and usable by the client. In some embodiments, based on the data destination, for example a message bus as the data destination, the configuration may be a replicator. As described above, a replicator can be used within a message bus to replicate data that goes through the message bus based on the data type requested to be provided to the replicator. Replicator data can be used to safeguard against loss of data during a fault, data corruption, and the like. In some embodiments, selecting the message bus configuration can include identifying that the language utilized by the client is not an expected language and generating a client message bus configuration for the client using the client type and the client configurations.

In some embodiments, the method may continue at block 1410 by deploying the message bus configuration at the client. In some embodiments, depending on the manageability of the client, the central system may have the ability to alter the configurations after deployment. In some embodiments, deploying the message bus configuration comprises maintaining the connection between the client and the message bus communication device.

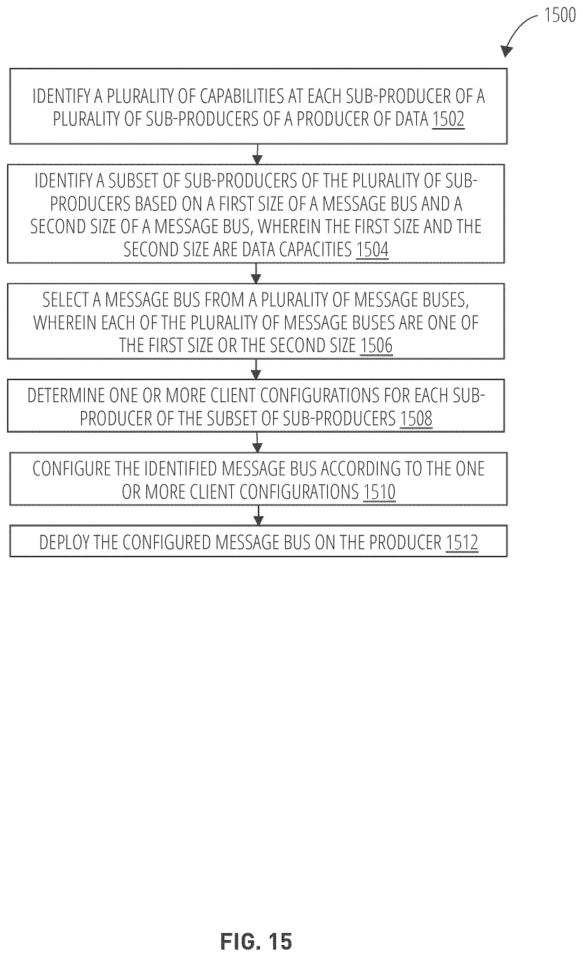

FIG. 15 is a flow diagram 1500 of a method of selecting and providing message buses at edge telecommunication locations according to at least one embodiment. As described above in at least FIG. 7, in some embodiments, the system can include the ability to have pre-generated message buses that can be deployed at edge devices. The method begins at block 1502 by identifying a plurality of capabilities at each sub-producer of a plurality of sub-producers of a producer of data. In some embodiments, capabilities of a producer can include, but are not limited to, producer computational support ability, producer storage availability, expected data throughput, expected data type generation, and the like. In some embodiments, the capabilities can be provided via a graphical user interface 800 by a user defining the capabilities of the producer. In some embodiments, the capabilities of the producer can be identified via characteristics known to the system of the producer. For example, an edge device that is an RDC with expected components may have a predictable capacity for the above. In some embodiments, previous capabilities for like producers may be identified by the system to surmise the plurality of capacities for the producer. For example, an LDC connected to an RDC may have similar capacities to a separate LDC connected to the same RDC and running the same components.

The method can continue at block 1504 by identifying a subset of sub-producers of the plurality of sub-producers based on a first size of a message bus and a second size of a message bus, wherein the first size and the second size are data capacities. For example, a first message bus can be configured as a first throughput size, and a second message bus can be configured as a second throughput size. Depending on the capacities identified for the producer, the first throughput size or the second throughput size may be selected, thereby allowing the system to identify the first on-site message bus or the second on-site message bus for deployment. In some embodiments, identifying the message bus can include determining a destination for the message bus, determining that the message bus has not previously been connected to the producer; and determining a language supported at the producer.

In some embodiments, identifying a message bus from a plurality of message buses can include selecting two distributed data modules of the first throughput size rather than a single module of the second throughput size. Selecting the first message bus and the second message bus can be to satisfy the plurality of capacities of the producer and minimize producer resource utilization. For example, if the required capacity is more than the capacity of the second throughput size but could be satisfied by the combination of the first throughput size. In some embodiments, the first size is associated with a first throughput capacity and a first producer resource utilization and the second size is associated with a second throughput capacity higher than the first throughput capacity and a second resource utilization higher than the first resource utilization. For example, a second throughput size may require double the computational resources and may have more than two times the capacity of the first throughput size. By selecting two of the first throughput size, the system may limit the number of computational resources used to the lowest possible amount based on the pre-set sizes and still satisfy the required capacity.

After identifying a message bus, the method may continue at block 1506 by selecting a message bus from a plurality of message buses, wherein each of the plurality of message buses is one of the first size or the second size. In some embodiments, the pre-generated message bus may be provided requests based on producer and/or consumer settings. For example, the message bus may be configured with requests to provide a first set of data to short-term storage and a second set of data to short-term storage based on data type and distribution time. In some embodiments, the message bus may be configured based on the manageability of the producer. For example, if the producer is managed external to the system, the message bus may need to be configured such that administration of the producer may receive the configured message bus (e.g., the configured message bus) and deploy the message bus on the producer internally. In some embodiments, the message bus may need to be configured such that the message bus is configured to accept telemetry data framework normalized data from sub-producers of a producer that generate data for next-generation telecommunication systems.

At block 1508, the method may include a message bus configured by determining one or more client configurations for each sub-producer of the subset of sub-producers. As discussed above, when preparing to deploy a message bus, the system may require client configurations to generate and deploy a proper instance of a message bus. A client configuration can include an intended destination for the message bus. Destinations can require different configurations. For example, a destination can be a producer on which the message bus will be deployed directly, a consumer that needs only a communication interface deployment to facilitate the connection with the message bus, or message bus which requires a configuration of a replicator for replicating the selected data. In some embodiments, connections have already been generated and rather than reconfiguring instructions, such as a communication interface deployment for a consumer, the system can utilize the previously generated deployment to shorten computation time for generating a new deployment. In some embodiments, to generate a deployment that will be usable at a source, the client configurations can include a language supported at the producer. As described above, next generation telecommunication systems can utilize open random access network components (O-RAN). O-RAN components can be components from one or more vendors that are wholly owned and operated by the vendors. Each vendor can determine the best coding language used for their purposes. As such, in a system with five sub-producers, each managed by a separate O-RAN vendor, a system may be required to accept event data generated at producers running five different coding languages. In order to create a connection point between the producers and the message bus, the system may be required to configure the deployment in the specific language usable by the O-RAN vendor.

The method ends at block 1512 by deploying the configured message bus on the producer. In some embodiments, deployment can include continually enabling the connection between the system, controller, the message bus, the producer, the consumer, and the like. In some embodiments, deploying the configured message bus may include providing requests to an externally managed producer to deploy the provided communication device.

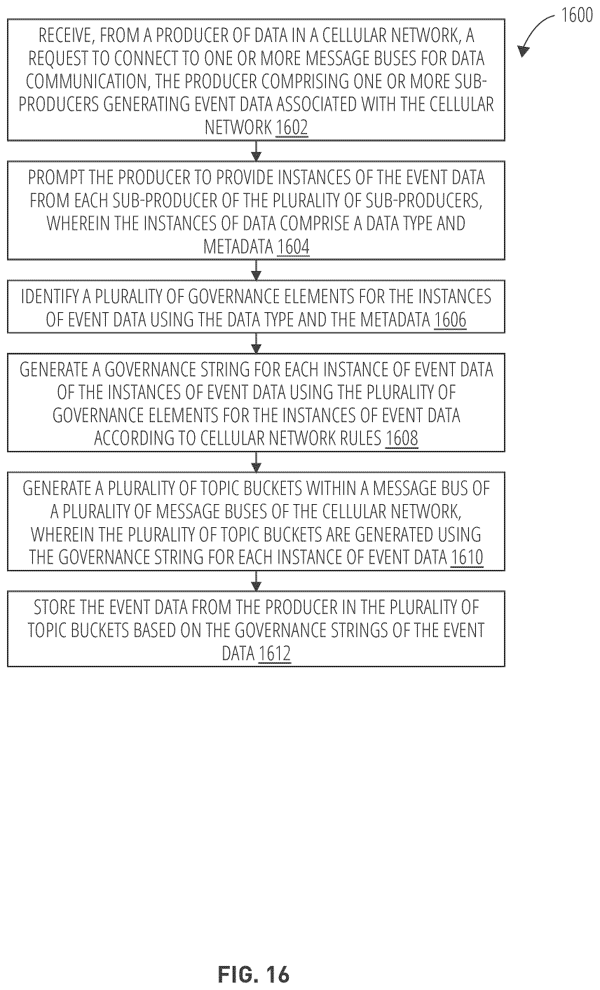

FIG. 16 illustrates a flow diagram 1600 of a method of identifying data for message bus transmission based on topic governance rules according to at least one embodiment. The method begins at block 1602, wherein the system receives, from a producer of data in a cellular network, a request to connect to one or more message buses for data communication, the producer comprising one or more sub-producers generating event data associated with the cellular network. As described above in at least FIG. 7 and FIG. 11, the request to connect to the producer may be a request to connect your producer for the first time, or a request to connect a producer to provide additional data information not previously included in configurations. The plurality of sub-producers can be O-RAN producers that are each managed and completely controllable by an external vendor. Each vendor of the plurality of sub-producers can determine naming conventions and data collection methods for the sub-producer that may need to be normalized to be properly understood by a message bus to be accurately passed to a consumer. The request may include client configurations that may be used to understand and interpret the data provided by the sub-producer, for example, a programming language utilized at the sub-producer.

The method continues at block 1604. In some embodiments, the system can prompt the producer to provide instances of the event data from each sub-producer of the plurality of sub-producers, wherein the instances of data comprise a data type and metadata, wherein the system prompts the producer to provide instances of event data for the plurality of sub-producers. As described above, a producer can be, for example an edge device such as an LDC that includes sub-producers that can be O-RAN components. The sub-producers can each be associated with a distinct vendor or can share common vendors. The producer may generate one or more instances of event data that indicate event data the producer intends to be provided to the system for data transmission to a consumer. The event data may be usable data by the consumer that is associated with specific event types or may be examples of all event data that can be produced by the producer. The instances of event data may be provided in the format generated by the producer and not a format altered for use at the system. For example, the producer generating communication data may provide raw event data as it is produced at the producer.

At block 1606, the system can identify a plurality of governance elements for the instances of event data using the data type and the metadata, as described in FIG. 12. To identify a plurality of governance elements, the system may mine the context of the payload of the sub-producers. As described above, by mining the context of the payload, the sub-producers, either autonomously or with the aid of a user, can identify the types of data that will be provided to the system that need to be named according to the normalized naming conventions of the system. In some embodiments, the context is identified using an LLM, user identification, and the like. Using the context of the payload, the context (e.g., producer naming conventions) of the data instances can be mapped to the plurality of governance elements (e.g., names) identified according to message bus system rules (e.g., naming rules). As described above, names can be generated according to a set of naming rules that identify the allowable characters that can be included in the data string. In some embodiments, the names can be generated by an administrator of the producer, an administrator of the system, a generative AI model, and the like. In some embodiments, the system will generate and maintain a mapping between the context of the payload and naming conventions used by the producer, and generated names according to the normalized naming conventions of the system.

The method may continue at block 1610 with generating a governance string for each instance of event data of the instances of event data using the plurality of governance elements for the instances of event data according to cellular network rules. As shown above, the data string may be generated in an order designated by the naming convention rules of the system such that the data string is populated in an order that can be expected by other components of the system. After generating the data string, the system can, either through input from administration of the producer, administrators of the system, autonomous system evaluation, preset string length, and the like, identify a string length for the governance string for each instance of event data according to the cellular network rules, wherein the governance string for each instance of event data of the string length includes at least one governance element; wherein the governance string length is a preset string length at the cellular network. The governance string length can include a string length of characters of the data stream, a string length of data types included in the string length, and the like. For example, a governance string length may be identified to include the three components: the organization, the wireless domain, and the functional area. In some embodiments, the governance string length can include the number of characters that are to be transmitted as part of the data string in which the characters are part of the names.

As described above, the message buses can include short-term data stores, and the system can include long-term data stores for storing data. Consumers may request data be stored in the short-term data store or the long-term data store based on event types. Event types can be identified using the names within the data stream. Each piece of data from an organization can be part of an event type associated with that organization. Each piece of data associated with a wireless domain may be part of an event type for that wireless domain. Event types may be segmented within any level of the data stream. For example, event types segmented by organization may be at a highest level, such that any data produced by the organization can be considered part of the event type. An event type segmented by the wireless domain may include one or more segments based on the number of wireless domains within the organization. Such segments will only include event types associated with the wireless domain and the organization, and data associated with the organization will be split between segments associated with the wireless domains. The event types may be segmented within the short-term data store and the long-term data store depending on the request submitted by the consumer.

Turning to block 1614, in order to separate the event types within the short-term data store and the long-term data store, the system may generate a plurality of topic buckets within a message bus of a plurality of message buses of the cellular network, wherein the plurality of topic buckets are generated using the governance string for each instance of event data. As described above, event types that are to be stored in the short-term data store are event types that the consumer has directed for data transmission with a low latency. Therefore, any topic buckets within the short-term data store may be exclusive to the short-term data store, and any topic buckets within the long-term data store may be associated with less time-sensitive event types.

At block 1616, the event data can be stored in the plurality of topic buckets based on the governance strings of the event data. When event data is provided from the producer to the message bus, the message bus can review the normalized naming convention data string to determine the event type that is associated with the topic buckets within the short-term data store and the long-term data store. Data associated with topic buckets in the short-term data store will be transferred to the short-term data store for temporary data storage before being transmitted to the consumer, and data associated with topic buckets in the long-term data store will be transferred to the long-term data store. In some embodiments, the event data within the short-term data store will be provided to a consumer prior to event data from the long-term data store. In some embodiments, the event data stored in the first set of topic buckets is provided to the consumer prior to the event data stored in the second set of topic buckets to the consumer. In some embodiments, the event data stored in the first set of topic buckets is provided to the consumer and the event data stored in the second set of topic buckets is maintained in the second set of topic buckets until the consumer requests the data or a time metric is met. The time metric may be set by the system or a user to control the amount of time event data is maintained in the long-term data store.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMS, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

In the above description, numerous details are set forth. It will be apparent, however, to one of ordinary skill in the art having the benefit of this disclosure, that embodiments may be practiced without these specific details. In some instances, well-known structures and devices are shown in block diagram form rather than in detail in order to avoid obscuring the description.

Some portions of the detailed description are presented in terms of algorithms and symbolic representations of operations on data bits within a computer memory. These algorithmic descriptions and representations are the means used by those skilled in the data processing arts to convey the substance of their work most effectively to others skilled in the art. An algorithm is used herein and is generally conceived to be a self-consistent sequence of steps leading to the desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “sending,” “receiving,” “scheduling,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, Read-Only Memories (ROMs), compact disc ROMs (CD-ROMs), and magnetic-optical disks, Random Access Memories (RAMs), EPROMs, EEPROMs, magnetic or optical cards, or any type of media suitable for storing electronic instructions. One or more non-transitory, computer-readable storage media can have computer-readable instructions stored thereon which, when executed by one or more processing devices, cause the one or more processing devices to perform the operations described herein.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present embodiments as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
receiving, from a producer of data in a cellular network, a first request to connect to one or more message buses for data communication, the producer comprising one or more sub-producers generating event data associated with the cellular network, wherein the event data is associated with a data type, and wherein the one or more message buses is associated with a short-term data store;
based on the event data produced by the one or more sub-producers, establishing a first connection between the producer and the one or more message buses;
receiving, from a consumer of data in the cellular network, a second request to obtain the event data, wherein the second request includes a storage duration and the data type;
identifying a message bus of the one or more message buses receiving the event data associated with the data type;
establishing a second connection between the consumer and the message bus;
causing the message bus to provide a first portion of the event data from the one or more sub-producers to the short-term data store; and
using the storage duration, causing the first portion of the event data to be provided from the short-term data store to the consumer.

2. The method of claim 1, further comprising facilitating a third connection between the message bus and a long-term data store.

3. The method of claim 2, using the storage duration and the data type, causing the message bus to provide a second portion of the event data to the long-term data store; and
upon indication from the consumer, causing the second portion of the event data to be transmitted from the long-term data store to the consumer.

4. The method of claim 1, wherein facilitating the connection between the producer and the one or more message buses further comprises:
providing sub-producer identifiers to the one or more message buses; and
causing the one or more message buses to use the sub-producer identifiers to retrieve data from a telemetry data framework.

5. The method of claim 1, wherein the first portion of the event data includes event data associated with the data type.

6. The method of claim 1, wherein the producer is one of a user device, radio unit, or distributed unit.

7. The method of claim 1, wherein the one or more sub-producers are open radio access network components.

8. A controller in a cellular network, the controller comprising:
a processing unit; and
a memory storing one or more executable instructions that when executed by the processing unit cause the controller to:
based on event data produced by one or more sub-producers of a producer, establishing a first connection between the producer and one or more message buses;
receive, from a consumer of data in the cellular network, a second request to obtain the event data produced at the one or more sub-producers of the producer, wherein the request includes a storage duration and a data type;
identify a message bus of the one or more message buses receiving the event data associated with the data type;
establishing a second connection between the consumer and the message bus;
cause the message bus to provide a first portion of the event data from the one or more sub-producers to a short-term data store associated with the one or more message buses; and
using the storage duration, causing the first portion of the event data to be provided from the short-term data store to the consumer.

9. The controller of claim 8, wherein the one or more executable instructions that when executed by the processing unit further cause the controller to facilitate a third connection between the message bus and a long-term data store.

10. The controller of claim 8, wherein the one or more executable instructions that when executed by the processing unit further cause the controller to:
using the storage duration and the data type, cause the message bus to provide a second portion of the event data to a long-term data store; and
upon indication from the consumer, cause the second portion of the event data to be transmitted from the long-term data store to the consumer.

11. The controller of claim 8, wherein the one or more executable instructions causing the controller to facilitate the connection between the producer and the one or more message buses further cause the controller to:
provide sub-producer identifiers to the one or more message buses; and
cause the one or more message buses to use the sub-producer identifiers to retrieve data from a telemetry data framework.

12. The controller of claim 8, wherein the first portion of the event data includes event data associated with the data type.

13. The controller of claim 8, wherein the producer is one of a user device, radio unit, or distributed unit.

14. The controller of claim 8, wherein the one or more sub-producers are open radio access network components.

15. A computing system comprising:
one or more processors; and
one or more memories storing instructions that, when executed by the one or more processors, causes the one or more processors to perform operations comprising:
based on event data produced by a producer comprising one or more sub-producers generating event data associated with a cellular network, establishing a first connection between the producer and one or more message buses for data communication;
using a data type from a request from a consumer of data in the cellular network, identifying a message bus of the one or more message buses receiving the event data associated with the data type;
establishing a second connection between the consumer and the message bus;
causing the message bus to provide a first portion of the event data from the one or more sub-producers to a short-term data store; and
using he storage duration, causing the first portion of the event data to be provided from the short-term data store to the consumer.

16. The computing system of claim 15, further comprising facilitating a third connection between the message bus and a long-term data store.

17. The computing system of claim 16, using a storage duration from the consumer and the data type, causing the message bus to provide a second portion of the event data to the long-term data store; and
upon indication from the consumer, causing the second portion of the event data to be transmitted from the long-term data store to the consumer.

18. The computing system of claim 15, wherein facilitating the connection between the producer and the one or more message buses further comprises:
providing sub-producer identifiers to the one or more message buses; and
causing the one or more message buses to use the sub-producer identifiers to retrieve data from a telemetry data framework.

19. The computing system of claim 15, wherein the first portion of the event data includes event data associated with the data type.

20. The computing system of claim 15, wherein the producer is one of a user device, radio unit, or distributed unit.
